(19) United States
(12) Patent Application Publication
(10) Pub. No.: US 2026/0290330 A1
(43) Pub. Date: Sep. 24, 2026

(54) SYSTEM

(71) Applicant: SoftBank Group Corp., Tokyo (JP)

(72) Inventor: Takahiro YANAGIDA, Tokyo (JP)

(73) Assignee: SoftBank Group Corp., Tokyo (JP)

(21) Appl. No.: 19/568,954

(22) Filed: Mar. 17, 2026

(30) Foreign Application Priority Data
Mar. 19, 2025 (JP) 2025-045212

(51) Int. Cl. G10L 15/18; G06F 40/20

(52) U.S. Cl. CPC G10L 15/1807; G06F 40/20

(57) ABSTRACT

A system includes a processor that is configured to: collect voice interactions with a user and convert collected voice data into text data, analyze the text data by using a natural language processing technique to extract information regarding a request and an intention of the user, and to classify basic emotions including joy, anger, sadness, and surprise expressed and recognize an emotional state, store, in a database as profile data of the user, the extracted information regarding the request, the intention, the interest, the desire, the worry, or the regret of the user and the recognized emotional state in association with each other, create a prompt and input the prompt into the generative AI model to generate a message, indirectly transmit the generated message to a terminal of the related target including the family member of the user other than the user, adjust a response content to the user.

### CROSS-REFERENCE TO RELATED APPLICATION

This application is based on and claims priority under 35 USC 119 from Japanese Patent Application No. 2025-045212 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional AI assistant systems mainly focus on functional support such as information retrieval and schedule management, and are not designed to deeply understand and utilize users' internal states, including interests, desires, worries, regrets, and emotional conditions, in a structured and persistent manner. As a result, such systems cannot effectively support emotional communication within a family or gently convey a user's latent awareness or wishes to related persons such as family members. Furthermore, known systems lack mechanisms for continuously analyzing accumulated user profile data to identify purchasing intentions, gift preferences for special days such as birthdays and anniversaries, regrets about past conflicts with family members, and current concerns, and for transforming these findings into personalized proposals or messages via a generative AI model. Consequently, there is a need for a system that not only performs conventional AI assistant functions, but also collects and analyzes user voice interactions, recognizes emotional states, stores the results as profile data, and, based on this data, indirectly and gently communicates the user's awareness and needs to related targets, while at the same time providing real-time adaptive responses to the user.

### SUMMARY

In order to solve the above-described problems, the present invention provides a system comprising a processor, wherein the processor is configured to collect voice interactions with a user and convert collected voice data into text data by using a speech recognition technique, analyze the text data by using a natural language processing technique to extract information regarding a request and an intention of the user and an interest, a desire, a worry, or a regret of the user, and to classify basic emotions including joy, anger, sadness, and surprise expressed by the user and recognize an emotional state, and store, in a database as profile data of the user, the extracted information and the recognized emotional state in association with each other. The processor is further configured to create, on the basis of the profile data, a prompt for instructing a generative AI model to generate a content that gently conveys an awareness of the user to a related target including a family member of the user, or to generate a personalized proposal in accordance with the emotional state or the interest of the user, to input the prompt into the generative AI model to generate a message or a proposal, and to indirectly transmit the generated message or proposal to a terminal of the related target other than the user. In addition, the processor is configured to analyze the profile data to identify a purchasing intention of the user, a desired gift for a special day including a birthday or an anniversary, a regret regarding a past conflict or quarrel with a family member or the like, and a current issue or worry of the user, and, on the basis thereof, to create a prompt for instructing the generative AI model to generate a personalized proposal or message. The processor is also configured to adjust response content to the user on the basis of the recognized emotional state and to present the adjusted response content in real time via a screen or a voice output of a user terminal, while providing an information retrieval function and a schedule management function based on a request of the user.

The term “processor” refers to one or more hardware circuits, such as a central processing unit (CPU), graphics processing unit (GPU), digital signal processor (DSP), application specific integrated circuit (ASIC), field programmable gate array (FPGA), or any combination thereof, that executes instructions to perform the functions described in the claims.

The term “voice interaction” refers to an exchange in which a user provides spoken input to the system, including utterances, conversations, commands, or questions, and the system processes and responds to such spoken input.

The term “speech recognition technique” refers to a software-implemented or hardware-implemented method or algorithm that converts audio data representing human speech into corresponding text data.

The term “text data” refers to a sequence of characters or symbols representing linguistic content that has been obtained by converting spoken audio or other input into a machine-readable textual form.

The term “natural language processing technique” refers to a computational method, algorithm, or model for analyzing, understanding, or generating human language, including but not limited to tokenization, parsing, semantic analysis, sentiment analysis, and intent detection.

The term “user's request” refers to an explicit or implicit demand, question, command, or instruction expressed by the user and recognized by the system through analysis of the user's input.

The term “user's intention” refers to an underlying purpose, goal, or aim that the user seeks to achieve and that is inferred by the system from the content and context of the user's input.

The term “interest” refers to a topic, object, activity, or field towards which the user exhibits curiosity, preference, or positive engagement, as inferred from the user's input and behavior.

The term “desire” refers to a wish, want, or aspiration of the user regarding goods, services, experiences, or relationships, as extracted from the user's input.

The term “worry” refers to a concern, anxiety, unease, or problem expressed or implied by the user about present or future events or conditions.

The term “regret” refers to a negative feeling or dissatisfaction expressed by the user about past actions, omissions, or events, including conflicts or quarrels, especially with family members or related persons.

The term “basic emotions” refers to fundamental emotional categories, including at least joy, anger, sadness, and surprise, and optionally other discrete emotions recognized by the system.

The term “emotional state” refers to a classification or representation of the user's current emotion or combination of emotions, determined by analyzing the user's input using natural language processing and other analytical techniques.

The term “profile data” refers to structured data stored for a user, including extracted information regarding the user's requests, intentions, interests, desires, worries, regrets, and recognized emotional states, together with any associated metadata.

The term “database” refers to any structured data storage system, including relational databases, NoSQL databases, key-value stores, or other persistent storage mechanisms, that is used to store and manage profile data and related information.

The term “generative AI model” refers to a machine learning model, such as a large language model, generative neural network, or similar generative model, that is capable of generating text-based content, messages, or proposals in response to an input prompt.

The term “prompt” refers to an input text or structured instruction provided to the generative AI model, specifying conditions, constraints, or objectives for generating a message, proposal, or other content.

The term “content that gently conveys an awareness of the user” refers to a generated message or text that communicates the user's realizations, wishes, or internal thoughts to a target in a considerate, non-intrusive, and emotionally supportive manner.

The term “personalized proposal” refers to a suggestion, recommendation, advice, or plan generated by the generative AI model that is tailored to the specific profile data, emotional state, interests, or circumstances of the user.

The term “message” refers to a unit of generated text, including but not limited to notifications, suggestions, reminders, or expressions of support, that is intended to be delivered to the user or to a related target.

The term “related target” refers to a person or entity associated with the user, including at least a family member of the user, and optionally including close friends, caregivers, or other designated persons.

The term “family member” refers to a person related to the user by blood, marriage, adoption, or cohabitation, such as a spouse, child, parent, sibling, or other household member registered in association with the user.

The term “terminal” refers to any user device capable of sending data to and receiving data from the system, including but not limited to a smartphone, tablet, personal computer, smart speaker, or wearable device.

The term “indirectly transmit” refers to transmitting a generated message or proposal to a related target in a manner that does not directly expose the full original conversation or raw emotional data of the user, but instead conveys processed or summarized content.

The term “response content” refers to text or other information that the system outputs to the user in reply to the user's input, including answers, explanations, confirmations, or conversational statements.

The term “user terminal” refers to a terminal that is operated by or assigned to the user, and that is used for providing voice interactions, receiving responses, and accessing assistant functions.

The term “information retrieval function” refers to a capability of the system to search, obtain, and present information requested by the user, such as weather, news, or general knowledge.

The term “schedule management function” refers to a capability of the system to create, modify, retrieve, and present calendar entries, reminders, and appointments associated with the user.

The term “purchasing intention” refers to a likelihood or tendency of the user to consider purchasing particular goods or services, as inferred from analysis of the user's profile data.

The term “special day” refers to a date of personal significance to the user, including at least birthdays, anniversaries, and other commemorative events.

The term “desired gift” refers to an item, service, or experience that the user wishes to receive on a special day, as inferred from the user's input or profile data.

The term “conflict or quarrel” refers to a disagreement, argument, or discord between the user and a family member or another related person, as expressed or implied in the user's input.

The term “current issue” refers to a problem, challenge, or concern that the user is presently facing, as identified from the user's profile data.

The term “real time” refers to a time frame that is sufficiently short to give the user the perception of an immediate or near-immediate response, typically within seconds from the user's input.

The term “expression that gently supports the target” refers to wording in a generated message or proposal that is polite, empathetic, and considerate, and that is intended to encourage or assist the related target without causing discomfort or pressure.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

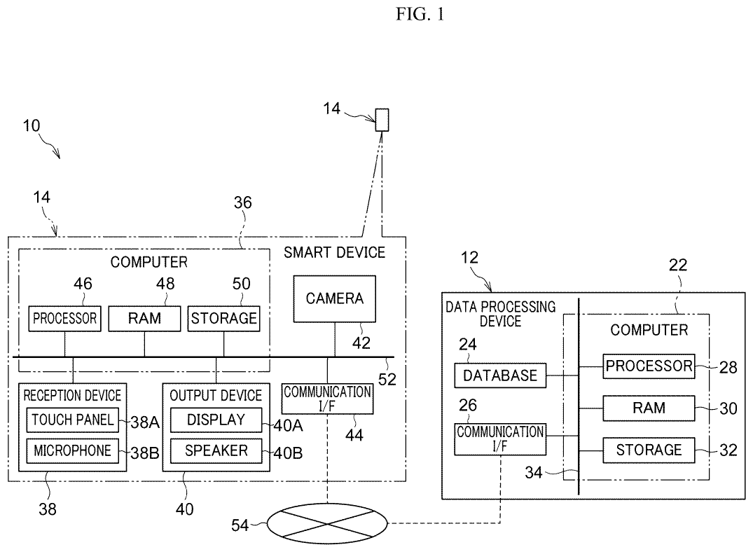

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

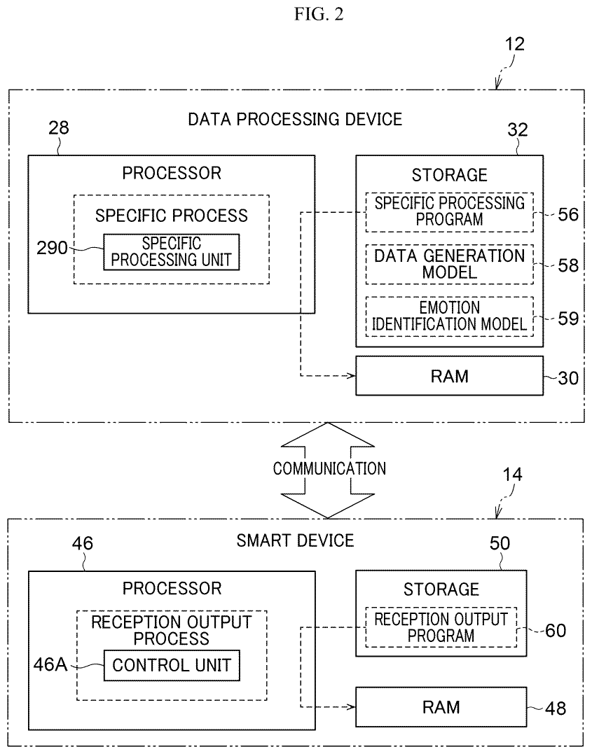

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialog systems and schedule-management systems primarily focus on a direct mapping from user input to fixed, template-based responses or simple information-retrieval results. These systems typically treat user requests, external information (such as environmental information or schedule data), and user-specific context (such as emotional state or long-term preferences) as separate, weakly coupled elements. As a result, such systems exhibit several technical limitations in terms of computer technology itself.

First, conventional systems generally perform natural language understanding, external data retrieval, and response generation as separate modules that do not share a unified representation of the user's state. Profile data, if stored at all, is usually limited to static attributes and is not dynamically updated with fine-grained emotional information or detailed associations between user intent, emotional state, and historical dialog content. This architecture leads to inefficient use of computational resources and results in repeated and redundant processing of similar user contexts, thereby causing unnecessary overhead in storage access, model invocation, and network communication.

Second, in many existing architectures, a generative AI model is invoked with minimal or ad-hoc context, often limited to the latest user utterance. The model is not systematically provided with integrated external data (such as up-to-date environmental information or schedule information) that has been normalized and associated with a structured user profile.

Consequently, the generative model must internally infer missing context from sparse inputs, which leads to unstable output quality and inconsistent personalization. In addition, because the prompt content is not generated through a structured, programmatic process that conditions on unified profile data and integrated external information, a large number of tokens must be transmitted to and processed by the generative model, increasing latency, computation time, and communication bandwidth usage.

Third, conventional systems typically adjust tone or politeness of responses in a superficial manner, for example by selecting from a small set of pre-defined templates or by adding fixed polite phrases. They do not employ a mechanism in which the user's emotional state, recognized from multi-turn dialog, is systematically stored as part of profile data and then programmatically reflected in both (i) real-time responses to the user and (ii) indirect messages or proposals addressed to related parties such as family members. This lack of a structured emotional profile limits the system's ability to algorithmically control the style, content, and target of generated messages, making it difficult to stabilize quality across sessions and to reduce trial-and-error runs of the generative AI model.

Fourth, known systems that offer both information-retrieval and schedule-management functions typically implement them as independent features without a shared orchestration logic that coordinates (i) intent classification, (ii) selection and querying of external information sources, (iii) integration of heterogeneous data, and (iv) construction of specialized prompt sentences for a generative AI model. Without such orchestration, the system cannot efficiently choose appropriate external services, cannot consistently integrate schedule information and environmental information, and cannot systematically reuse previous profile data for new tasks. This leads to duplicated processing, fragmented state management, and scalability issues when the number of users and external services increases.

Fifth, in conventional architectures, indirect communication to related parties (for example, family members) is handled outside the core dialog engine or by separate applications. This division prevents the system from leveraging the same integrated profile data, emotional state recognition, and external information for the generation of both user-facing responses and third-party-facing messages. As a result, the system must perform repeated data retrieval and redundant model invocations, and cannot optimize transmission timing, security policies, and presentation styles on an integrated basis.

Accordingly, there is a need for an improved computer-implemented system that (i) unifies dialog data processing, emotional-state recognition, profile-data management, and external-information integration, (ii) programmatically constructs prompt sentences tailored to both user-facing and third-party-facing outputs, (iii) supplies a generative AI model with structured, integrated context to improve computational efficiency and output consistency, and (iv) provides information-retrieval and schedule-management functions while algorithmically adjusting response content and style based on a user's recognized emotional state. Such a system should improve the efficiency of processor use, memory use, and network communication; reduce redundant computation in model invocation; and enhance the technical performance of dialog processing and schedule-management functions on a computing platform.

The specific processing by the specific processing unit 290 of the data processing device 12 in Example 1 is realized by the following means.

The present invention provides a server comprising a processor configured to acquire dialog data from a user as an audio signal or a character string and generate text data by performing a speech recognition process on the audio signal or a character-string acquisition process on the character string, to analyze the text data by performing natural language processing so as to interpret a request and an intention of the user, identify whether the request is an information-acquisition request or a schedule-management request, classify and recognize an emotional state of the user from the text data, and associate the request, the intention, and the emotional state as attribute information of the user to store as profile data in a storage device, to determine, based on an analysis result, a type of access to an external information source, acquire environment information from an information-providing service in response to the information-acquisition request, acquire schedule information from a schedule-management service or a schedule database in response to the schedule-management request, and integrate and manage the acquired environment information or the acquired schedule information as an internal data structure, to generate, based on the integrated environment information or schedule information and the profile data, a prompt sentence for a generative AI model, the prompt sentence instructing the generative AI model to generate, according to a type of the request and the emotional state of the user, a natural-language response that explains an information-retrieval result or schedule information in an easy-to-understand manner and to generate a personalized proposal or a message to a related party other than the user according to the emotional state and an interest of the user, to input the generated prompt sentence into the generative AI model and, by numerical computation processing of the generative AI model including the integrated environment information or schedule information, generate a natural-language response for the user and a natural-language message or a proposal for the related party other than the user, to indirectly transmit the generated natural-language message or proposal for the related party other than the user to an information-processing terminal used by the related party, and to adjust, based on the recognized emotional state of the user, expression content and a presentation mode of the generated natural-language response for the user, and present the generated natural-language response in real time via a display unit or an audio output unit of an information-processing terminal used by the user while providing an information-retrieval function for the information-acquisition request and a schedule-management function for the schedule-management request. This enables unified and efficient control of dialog processing, external-information integration, and generative AI model invocation on a computing platform, thereby reducing redundant computation and network traffic, improving consistency and personalization of generated natural-language outputs to the user and to related parties, and enhancing overall performance and scalability of information-retrieval and schedule-management functions implemented by the server.

The term “dialog data” refers to information representing an interaction between a user and a system, including at least an audio signal or a character string that expresses the user's utterance or input.

The term “audio signal” refers to time-series data representing sound captured by an input device, such as a microphone, and suitable for processing by a speech recognition process.

The term “character string” refers to a sequence of characters encoded in a digital format, such as a text input provided by a user through a keyboard, touch interface, or similar input device.

The term “speech recognition process” refers to a computational procedure that converts an audio signal into text data by analyzing acoustic features and mapping them to linguistic units using a software or hardware based recognition engine.

The term “text data” refers to digital data composed of characters or tokens that represent a linguistic content of the user's utterance and that is suitable for processing by a natural language processing component.

The term “natural language processing” refers to a set of computational techniques for analyzing and understanding text data in a human language, including at least tokenization, syntactic analysis, semantic analysis, intent recognition, and entity extraction.

The term “request of the user” refers to a functional demand expressed by the user in dialog data, including at least an information-acquisition request or a schedule-management request.

The term “intention of the user” refers to a purpose or goal underlying the user's request as inferred from the text data by natural language processing.

The term “information-acquisition request” refers to a type of request in which the user asks the system to obtain or present external information, such as environmental information, status information, or other factual data.

The term “schedule-management request” refers to a type of request in which the user asks the system to register, retrieve, modify, or summarize schedule information associated with the user.

The term “emotional state of the user” refers to a psychological condition of the user, such as joy, anger, sadness, or surprise, that is inferred from dialog data by a classification process.

The term “attribute information of the user” refers to data representing characteristics of the user, including at least the request, the intention, and the emotional state recognized from dialog data.

The term “profile data” refers to a data structure stored in a storage device that accumulates and associates attribute information of the user over time, including at least requests, intentions, emotional states, and related contextual information.

The term “storage device” refers to a memory component or data storage apparatus, such as a semiconductor memory, magnetic storage, or optical storage, used to store profile data and other information.

The term “analysis result” refers to information output from a natural language processing component, including at least the identified request type, the intention, and the emotional state of the user.

The term “external information source” refers to a system or service separate from the server that provides data upon request, including at least an information-providing service or a schedule-management service.

The term “information-providing service” refers to a service that provides environment information or other external data through a network interface in response to a query.

The term “environment information” refers to data describing an external state or condition relevant to the user's request, such as weather information, location-based information, or other contextual information.

The term “schedule-management service” refers to a service that stores and provides schedule information associated with users, accessible through a network interface.

The term “schedule database” refers to a data storage resource that maintains schedule information, including event times, titles, and related metadata, for one or more users.

The term “schedule information” refers to data representing events or appointments associated with a user, including at least event names, times, dates, and optionally locations.

The term “internal data structure” refers to a representation of environment information or schedule information within the server, such as a record, list, or object, suitable for computational processing and integration.

The term “generative AI model” refers to a machine learning model configured to generate natural-language text based on input data, including at least a neural network that performs numerical computations on tokenized representations.

The term “prompt sentence” refers to a text or structured input provided to the generative AI model that specifies a task and supplies context, including at least instructions regarding response content, style, and target.

The term “natural-language response” refers to a sequence of words in a human language generated by the generative AI model to answer or react to a user's request.

The term “personalized proposal” refers to a natural-language suggestion or recommendation generated for a specific user based on profile data, including at least the user's emotional state and interests.

The term “message to a related party other than the user” refers to a natural-language text generated for a recipient who is associated with the user, such as a family member or acquaintance, and not the user himself or herself.

The term “interest of the user” refers to a preference, concern, or topic of relevance to the user as inferred from profile data and dialog history.

The term “numerical computation processing of the generative AI model” refers to internal operations of the generative AI model, including at least matrix computations, non-linear transformations, and probabilistic token generation performed on input representations.

The term “information-processing terminal” refers to an electronic device capable of communication with the server, data display, and audio output, such as a smartphone, tablet, or personal computer.

The term “indirectly transmit” refers to sending data for a message or proposal to a related party other than the user through a communication path or application that does not require the user to manually forward the message content.

The term “expression content” refers to lexical choices, phrasing, and structure of a natural-language response, including tone, level of politeness, and degree of detail.

The term “presentation mode” refers to a manner in which a natural-language response is presented to the user, including at least visual display on a screen and audio output through a speaker.

The term “display unit” refers to a component of an information-processing terminal that visually presents text, images, or graphical user interface elements.

The term “audio output unit” refers to a component of an information-processing terminal, such as a speaker or headphone interface, that outputs sound generated from digital audio data.

The term “information-retrieval function” refers to a capability of the system to obtain and present environment information or other external data in response to an information-acquisition request.

The term “schedule-management function” refers to a capability of the system to handle schedule information, including retrieving, summarizing, or presenting events in response to a schedule-management request.

In one embodiment, a server, a terminal, and a user cooperate to implement the claimed system. The server includes at least one multi-core central processing unit (CPU), a memory, a non-volatile storage device, a network interface, and optionally at least one graphics processing unit (GPU) for accelerating neural-network inference. The terminal includes an input unit such as a microphone and a touch display, a local processor, a memory, a network interface, and an audio output unit such as a speaker. The user interacts with the terminal through voice or text to use information-retrieval and schedule-management functions provided by the server.

The server executes a program stored in the storage device and loaded into the memory. The program is implemented using an operating system and an application framework, such as a general-purpose server operating system with a web framework. The server uses machine-learning frameworks such as TensorFlow or PyTorch to execute a generative AI model, and may use a natural-language processing library to perform tokenization and intent classification. The server communicates with external information sources, such as weather information services or calendar services, via a communication protocol such as HTTPS over TCP/IP.

The server stores dialog data, profile data, and integrated external information in a structured manner in the storage device. For example, the server uses a relational database management system to manage tables representing user profiles, dialog history, schedule entries, and environment information. Each user profile record includes fields such as a user identifier, historical requests, inferred intentions, emotional state categories, and aggregated statistics about user interests. The server maintains an internal data structure, such as an in-memory object graph or a set of hash maps and lists, that mirrors portions of these tables to reduce latency when constructing prompt sentences and invoking the generative AI model.

The terminal captures an audio signal representing the user's utterance through the microphone. The terminal uses speech recognition software, which may be provided by a platform-level speech framework or by a local automatic speech recognition engine, to convert the audio signal into text. The terminal segments the audio signal into frames, extracts acoustic features such as Mel-frequency cepstral coefficients, and passes these features to an acoustic model implemented as a neural network. The terminal receives a sequence of characters as recognized text and packages this text together with metadata such as a timestamp, a user identifier, and optional location information, as structured data to be sent to the server via network communication.

Alternatively, the user directly inputs a character string using the touch display or keyboard of the terminal. In this case, the terminal treats the typed input as text data without performing speech recognition. The terminal encodes the text data in a standardized encoding format and transmits the encoded text to the server via the network interface.

The server receives the text data and performs natural language processing using a trained intent-classification model. In one embodiment, the server applies tokenization to the text, mapping the text to a sequence of tokens according to a predefined vocabulary. The server uses an encoder model, such as a transformer-based classifier trained using a cross-entropy loss function, to compute a vector representation of the input tokens. The server then predicts a request type, such as an information-acquisition request or a schedule-management request, and also infers an intention such as “ask for weather,” “ask for today's schedule,” or “request a reminder.”

The server further analyzes the text data to classify the emotional state of the user. For example, the server uses a multi-class classifier that maps the encoded text representation to an emotional label such as joy, anger, sadness, or surprise. The classifier is trained in advance using supervised learning, where labeled dialog data with known emotional categories is used as training data. During training, the server minimizes a loss function such as categorical cross-entropy, and updates the weights of the neural network by a gradient-based optimization algorithm.

The server associates the recognized request, intention, and emotional state with the user identifier and stores this association as profile data in the storage device. The profile data is updated incrementally at each interaction. For example, the server appends an entry to a dialog history table linking the current utterance, the inferred intention, the emotional label, and any external information retrieved in response. The server also updates aggregated profile fields, such as a distribution of emotional states over recent sessions, or a list of frequently requested topics.

The server uses the analysis result to determine the type of external information source to access. If the request type is an information-acquisition request concerning environmental conditions, the server queries an external information-providing service, such as a weather information service, via an API. The server sends a request including parameters such as location coordinates and date or time, and receives a response containing environment information, such as weather conditions, predicted temperatures, or other contextual data. If the request type is a schedule-management request, the server interacts with a schedule-management service or a schedule database. The server uses an API or database query language to retrieve schedule information for the user, such as upcoming events, event times, and event descriptions.

The server normalizes the retrieved environment information or schedule information into an internal data structure. For example, the server maps raw JSON fields from the external service into strongly typed objects or records, and indexes them by user identifier and time.

This integration allows the server to access relevant environment information or schedule information with low latency during prompt-construction and response-generation phases. By centralizing this integration, the server avoids repeated parsing and transformation of external data for each generative AI call, thereby improving processing speed and reducing processor load.

The server generates a prompt sentence for the generative AI model based on the integrated environment information or schedule information and the profile data. The server employs a prompt-construction module implemented as program logic that selects template fragments and parameter slots according to the request type, the intention, and the emotional state. For example, the server builds a prompt sentence that contains: (i) an instruction specifying the task, (ii) a description of the user's request and emotional state, (iii) structured environment or schedule information, and (iv) constraints on style and length. By programmatically generating this prompt sentence, the server supplies only essential context and structured data to the generative AI model, thereby reducing the number of tokens to be processed and lowering communication and computation costs.

In one example related to weather information, the server prepares a prompt sentence such as: “The user is asking for tomorrow's weather. The latest weather data is as follows: condition=clear, high temperature=25 degrees Celsius, low temperature=18 degrees Celsius. Please explain this information in simple and polite Japanese so that the user can easily understand it.”

In another example related to schedule management, the server prepares a prompt sentence such as:

“The user wants to know their schedule for tomorrow morning. The schedule data is: 1) Team meeting from 9:00 to 10:00. 2) Client call from 11:00 to 11:30. Please summarize this schedule in Japanese in a concise and easy-to-understand way and adjust the tone according to a calm emotional state.”

In a further example involving a related party, the server prepares a prompt sentence such as: “The user has recently felt regret about past conflicts with a family member and wishes to express this awareness gently. Based on the profile data indicating sadness and desire for reconciliation, please generate a considerate and mild message in Japanese that conveys the user's feelings and hopes for improved communication to the family member.”

The server provides the generated prompt sentence as input to the generative AI model. The generative AI model is implemented as a neural network, such as a transformer-based language model with multiple self-attention layers and feed-forward layers. The model architecture includes an input embedding layer that maps tokens to dense vectors, a stack of attention blocks that compute context-aware representations via matrix multiplications and non-linear activation functions, and an output layer that predicts token probabilities for each position. The model parameters are trained in advance on large amounts of language data using an unsupervised language modeling objective, such as next-token prediction, and may be further fine-tuned on domain-specific data, including dialog context and schedule-related text.

The server uses a machine-learning framework such as TensorFlow or PyTorch to perform numerical computation processing required by the generative AI model. By running the model on dedicated hardware such as a GPU, the server parallelizes matrix multiplications and accelerates inference. The server supplies tokenized prompt sentences to the model and obtains a sequence of output tokens that constitute a natural-language response. The server decodes the output tokens into text and may apply post-processing, such as truncation at sentence boundaries or deletion of extraneous content not consistent with the prompt sentence.

Because the prompt sentence integrates environment information or schedule information in a structured manner and because the profile data provides a concise summary of the user's emotional state and long-term interests, the generative AI model does not need to infer such context implicitly from long dialog histories. This design reduces the number of tokens that must be encoded and processed, improves memory locality in the neural network, and shortens inference time. As a result, the server achieves improved processing speed and lower resource consumption compared to a system that repeatedly supplies entire dialog histories to the generative AI model for each response.

After obtaining the natural-language response for the user and any natural-language message or proposal for a related party, the server uses the recognized emotional state to adjust expression content and presentation mode. For example, if the emotional state indicates high stress or sadness, the server selects wording that avoids abrupt or harsh expressions, and may choose to present information in smaller, easily digestible segments. This adjustment is performed by programmatic rules applied to the generated text, such as replacing specific terms with more polite synonyms, inserting reassurance phrases, or simplifying complex explanations. The server controls the terminal by sending metadata indicating whether the response should be spoken aloud, displayed as text, or both, depending on the emotional state and the user's past preferences encoded in the profile data.

In one embodiment, the server transmits a user-facing natural-language response to the terminal. The terminal displays the response text on the display unit using a graphical user interface component and optionally converts the text into an audio signal using a text-to-speech engine. The terminal then outputs the audio signal through the speaker. In this manner, the system is directly tied to actual operation of hardware components, such as the display and the speaker, and is not limited to abstract data manipulation.

In another embodiment, the server generates a message or proposal for a related party and transmits this message indirectly to a terminal used by the related party. For example, the server uses a messaging service or email delivery service to send the natural-language message without requiring the user to manually copy and paste content. The server may apply access-control rules and encryption before transmission. By centralizing this processing within the server, the system reuses the same profile data and integrated external information for both user-facing and third-party-facing outputs, eliminating redundant external calls and redundant generative AI invocations. This contributes to lower communication load and improved scalability of the system when many users are served simultaneously.

Because the server maintains unified profile data and integrated external information for each user, and because the prompt sentence is systematically constructed from these elements, the server improves data management and computational efficiency compared to conventional, loosely coupled architectures. The server reduces repeated parsing and interpretation of similar requests and reuses existing profile entries and cached external information where appropriate. This results in reduced access to external services and databases, further lowering network usage and latency.

In another embodiment, the server uses alternative generative AI model architectures, such as a mixture-of-experts model or a smaller distilled model for low-latency scenarios. The prompt-construction mechanism remains substantially the same: the server constructs a prompt sentence that explicitly encodes request type, intention, emotional state, and integrated external information. The use of such a prompt sentence as an intermediate representation enables different models to be swapped or scaled horizontally without changing the outer logic of dialog management, thereby improving maintainability and extensibility of the system.

In a further embodiment, the server employs additional rule-based post-processing modules that apply non-conventional or domain-specific rules to the output of the generative AI model. For example, the server checks schedule summaries generated by the generative AI model against the integrated schedule information, and corrects inconsistencies by referencing the underlying data structure. This hybrid approach, combining neural-network generation with deterministic consistency checks, is not a mere automation of human judgment; rather, it leverages the computational advantages of numerical optimization and large-scale pattern recognition while ensuring reliable alignment with structured data. This yields improved accuracy and reduced error rates in schedule-related outputs.

The described architecture and processing flow improve computer technology itself. The server reduces computational redundancy by integrating profile data and external information into compact internal data structures and by generating prompt sentences that encode only relevant information. The server reduces communication bandwidth and latency by sending concise prompt sentences to the generative AI model instead of full dialog histories. The server improves response quality and consistency by programmatically conditioning generation on a unified view of the user's emotional state, intentions, and external context.

Through these mechanisms, the system achieves technical effects such as increased processing speed, lower resource consumption, higher accuracy in intent and emotion recognition, and more stable personalization, which are not attainable by mere manual processing or simple template-based automation.

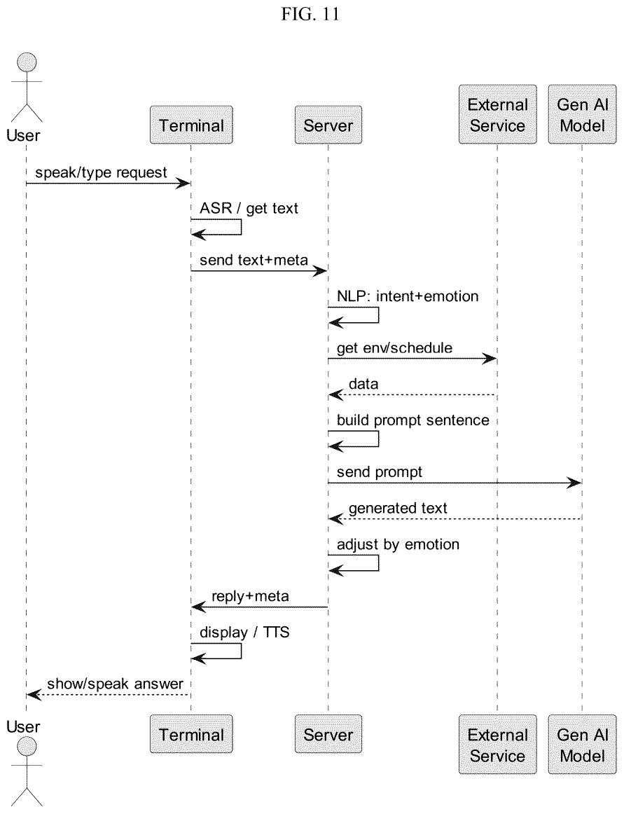

The following describes the processing flow using FIG. 11.

### Step 1

The user provides a request to the terminal.

The user speaks an utterance such as “Tell me tomorrow's weather” or “Show me my schedule for tomorrow morning” into a microphone of the terminal, or types a text request into a text input field displayed on a touch screen.

Input: The input is an analog audio signal captured by the microphone, or a sequence of characters entered via the touch screen or keyboard.

Output: The output is a raw user input stream (audio frames or typed characters) that the terminal will process in subsequent steps.

### Step 2

The terminal converts the raw user input into digital text data.

The terminal samples the audio signal at a predetermined sampling rate and segments the audio into frames. The terminal extracts acoustic features, such as Mel-frequency cepstral coefficients, from each frame and supplies the features to a speech recognition engine. The terminal executes an acoustic model and a language model to decode the audio into a text string. When the user types text, the terminal directly stores the characters as a text string.

Input: The input is the audio frames and their acoustic features, or the typed character sequence.

Output: The output is a recognized or captured text string representing the user's request, encoded in a character format suitable for transmission.

### Step 3

The terminal prepares a structured request and sends it to the server.

The terminal constructs a data object that includes the text string, a user identifier, a timestamp, and optional context such as language or location. The terminal serializes this object in a structured format and uses a communication protocol to transmit the object to the server over a network.

Input: The input is the text string and local metadata (user ID, timestamp, context).

Output: The output is a structured request message transmitted to the server as digital packets, which the server receives as a request payload.

### Step 4

The server receives the structured request and parses it.

The server accepts the incoming network packets, reconstructs the request message, and decodes the structured format. The server extracts the user identifier, the text string, and the metadata fields. The server stores a copy of the raw request in a log storage for later reference.

Input: The input is the structured request message received over the network.

Output: The output is an internal representation of the request, including the text query, user identifier, and context, held in memory as data structures such as objects or records.

### Step 5

The server performs natural language preprocessing on the text string.

The server tokenizes the text string into tokens according to a predefined vocabulary and performs normalization operations, such as lowercasing (where appropriate), removal of extraneous spaces, and conversion of numerals to a canonical form. The server may also perform sentence splitting if the text contains multiple sentences.

Input: The input is the raw text string from the request.

Output: The output is a token sequence and associated normalized text that will be used for intent classification and emotion classification.

### Step 6

The server determines the request type and user intention by intent classification.

The server feeds the token sequence into an intent-classification model implemented as a neural network or other classifier. The server computes a vector representation of the input using an embedding layer and one or more hidden layers. The server then applies a final classification layer to produce probabilities over predefined intent classes, such as “information-acquisition request” and “schedule-management request,” and more detailed sub-intents, such as “weather inquiry” or “next-event inquiry.”

Input: The input is the token sequence and normalized text produced in the previous step.

Output: The output is an intent label and possibly a sub-intent label, represented as categorical data, together with a confidence score.

### Step 7

The server recognizes the emotional state of the user from the text.

The server supplies the same or an additional token sequence into an emotion-classification model, which may share an encoder with the intent-classification model or may be implemented as a separate neural network. The server computes an embedding vector and applies a classification layer to estimate probabilities for emotional categories such as joy, anger, sadness, and surprise. The server selects the category with the highest probability as the emotional state.

Input: The input is the token sequence (and optionally the normalized text) representing the user's utterance.

Output: The output is an emotional state label and an associated confidence score.

### Step 8

The server updates profile data based on the recognized intent and emotional state.

The server associates the user identifier with the newly determined intent, sub-intent, and emotional state and writes this association into a profile data storage area. The server adds a new dialog history record containing fields for the text string, intent, emotional state, timestamp, and reference to any related external information. The server may also update aggregated profile statistics, such as counts of each emotional state or frequent topics, by incrementing counters in a profile table.

Input: The input is the user identifier and the classification results (intent, sub-intent, emotional state) along with the original text.

Output: The output is an updated profile record stored in a database or other storage system, and an in-memory profile object ready for use in later steps.

### Step 9

The server determines which external information source to access.

The server examines the intent and sub-intent labels and selects an appropriate external service. For example, the server chooses a weather information service when the intent is a weather inquiry, or chooses a schedule-management service or schedule database when the intent is a schedule-related inquiry. The server constructs query parameters such as date, time range, and location from the text and profile data.

Input: The input is the intent, sub-intent, and context information (such as date and location) obtained from the request and the profile data.

Output: The output is a decision regarding which external information source to use and a prepared set of query parameters for that source.

### Step 10

The server retrieves environment information or schedule information from an external source.

The server sends a query to the selected external information source, including the prepared query parameters. For a weather information source, the server transmits location and date parameters and receives environment information such as predicted temperatures and conditions. For a schedule-management source, the server transmits the user identifier and a time range and receives schedule entries such as event times and descriptions. The server parses the external response and maps the raw fields into internal variables.

Input: The input is the query parameters and the location of the external service.

Output: The output is a set of normalized environment information or schedule information objects stored in memory and optionally cached in storage.

### Step 11

The server integrates the retrieved external information into an internal data structure.

The server organizes the environment information or schedule information into a structured format such as an object graph, a list of records, or a map keyed by time. The server links each piece of external information to the corresponding user identifier and current dialog context. The server may merge new information into existing cached data, replacing outdated entries and maintaining version or timestamp metadata.

Input: The input is the normalized external information objects and the current user identifier.

Output: The output is an integrated internal data structure that represents current environment information or schedule information for the user and is associated with the profile data.

### Step 12

The server constructs a prompt sentence for a generative AI model.

The server gathers the following elements: (i) the recognized intent and sub-intent, (ii) the emotional state, (iii) the integrated external information, and (iv) relevant portions of the profile data. The server uses these elements to fill slots in predefined template fragments or to build a prompt sentence using a programmatic prompt-construction algorithm. The server assembles an instruction part, a context part describing the data, and style constraints that guide tone and length.

Input: The input is the intent label, the emotional state label, the integrated external information or schedule information, and selected profile data.

Output: The output is a prompt sentence expressed as a natural-language string that instructs the generative AI model regarding what type of response to generate and how to incorporate the provided data.

### Step 13

The server invokes the generative AI model with the constructed prompt sentence.

The server tokenizes the prompt sentence into tokens according to the vocabulary of the generative AI model and creates a sequence of token IDs. The server provides these token IDs to the generative AI model implemented in a machine-learning framework, optionally using a GPU to accelerate matrix calculations. The model processes the tokens through an embedding layer, multiple self-attention layers, and output layers to generate a sequence of output token IDs corresponding to a natural-language response.

Input: The input is the tokenized prompt sentence, including the structured context about environment or schedule information and profile data.

Output: The output is a sequence of generated tokens, which the server decodes into a generated text response.

### Step 14

The server post-processes the generated text response.

The server converts the token sequence into a character string and inspects the text for adherence to length and style constraints. The server may remove redundant phrases, trim incomplete trailing sentences, and perform substitutions to harmonize terminology with system-defined vocabulary. The server may also check numeric values or time expressions in the generated response against the integrated external information or schedule information to ensure consistency and, if necessary, correct mismatched values.

Input: The input is the raw generated text produced by the generative AI model.

Output: The output is a cleaned and validated natural-language response text ready for delivery to the user and, where applicable, to a related party.

### Step 15

The server adjusts expression content and presentation metadata based on the emotional state of the user.

The server uses the emotional state label and profile statistics to determine whether the wording should be more formal, more reassuring, or more concise. The server applies rule-based transformations to the text, such as inserting supportive phrases, choosing softer lexical alternatives, or simplifying complex sentences. The server also sets presentation flags to indicate whether the response should be spoken, displayed, or both, and whether additional visual emphasis is appropriate.

Input: The input is the validated natural-language response text, the emotional state label, and profile-based preference data.

Output: The output is an adjusted response text and associated presentation metadata, such as tone category and output modality flags.

### Step 16

The server prepares and sends a response message to the terminal and, when applicable, to a related party's terminal.

The server encapsulates the adjusted response text and the presentation metadata into a structured response destined for the user's terminal. When a message or proposal for a related party exists, the server similarly encapsulates that content into a message for the related party's terminal or communication endpoint. The server transmits these messages over the network using communication protocols.

Input: The input is the adjusted response text and associated presentation metadata for the user, and optionally a separate message text for a related party.

Output: The output is one or more response messages transmitted to the respective terminals, each containing the content and instructions for presentation.

### Step 17

The terminal receives the server response and prepares the output for the user.

The terminal decodes the received structured response and extracts the natural-language text and presentation metadata. The terminal determines whether to display the text, to synthesize audio, or to perform both actions. If audio output is requested, the terminal passes the text to a text-to-speech engine and generates an audio signal. The terminal configures the display to show the text in a chat bubble or other UI element according to the metadata (such as emphasis or layout).

Input: The input is the structured response message received from the server.

Output: The output is a visual representation on the display unit and/or an audio signal ready for playback through the speaker.

### Step 18

The user receives the response through the terminal.

The terminal presents the text on the display and/or plays the synthesized speech through the speaker. The user reads or listens to the response, such as “Tomorrow will be clear with a high of 25 degrees,” or a summary of the next day's schedule. The user may then decide to enter another request or to act based on the information provided.

Input: The input is the displayed text and/or audible output produced by the terminal.

Output: The output is user comprehension and possible initiation of a subsequent interaction, which becomes new dialog data for the system when the user next provides a request.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional in-store support systems and dialog systems typically rely on static rule-based logic or simple database queries to answer user questions about item availability and to provide recommendations. In such systems, the processing pipeline from speech input to final response is fragmented: speech recognition, intent detection, database retrieval, and recommendation generation are implemented as separate subsystems with limited integration. As a result, these systems suffer from several technical limitations.

First, conventional systems do not tightly couple user profile data, purchase history data, and real-time item information in the generation of response content. The response logic is often based on predefined templates that do not dynamically adapt to a user's evolving behavior, preferences, or interaction history. This leads to low relevance of results and requires repeated manual tuning of rules and templates.

Second, typical systems do not systematically transform structured internal state (such as inventory records, co-purchase statistics, and user history) into optimized prompt sentences suitable for input to a generative AI model. Without an integrated prompt construction mechanism, the generative model is either underutilized or used in an ad hoc manner, which can cause unpredictable responses, increased latency due to inefficient prompt design, and inconsistent personalization quality. Furthermore, because the generative model is not guided by a well-structured prompt reflecting the system's data processing pipeline, it is difficult to maintain deterministic behavior, consistency of format, and compliance with user-interface constraints.

Third, existing augmented-reality presentation systems generally treat the display layer as independent from the dialog and recommendation engine. They lack a feedback loop where the user's interactions with augmented-reality content are captured as machine-readable signals and reintegrated into a unified purchase history data structure. As a consequence, the system cannot exploit interaction data at the AR layer to refine future prompts and improve the behavior of the generative AI model over time, which limits the technical advantages of personalization.

Fourth, known architectures do not provide a unified control mechanism in which a processor orchestrates: (i) acquisition and recognition of voice input, (ii) natural-language analysis of text and item identification information, (iii) retrieval and scoring of item information and related items, (iv) generation and iterative updating of prompt sentences for a generative AI model, and (v) real-time augmented-reality presentation on a terminal. The absence of such an integrated design results in higher computational overhead, increased network traffic due to redundant queries, and degraded response time.

Accordingly, there is a need for a computer-implemented system that technically improves the end-to-end pipeline for in-store conversational assistance by: unifying speech recognition, natural-language processing, data retrieval, recommendation scoring, and generative-model prompting; maintaining and using user profile data and purchase history data as core, machine-readable state; and using this state to automatically construct optimized prompt sentences for a generative AI model and to drive an augmented-reality display. Such a system should provide improved processing efficiency, more consistent and personalized responses, and a tighter feedback loop between user interactions and the internal data structures that guide future system behavior.

The specific processing by the specific processing unit 290 of the data processing device 12 in Application Example 1 is realized by the following means.

The present invention provides a server comprising a processor and a memory storing instructions which, when executed by the processor, cause the processor to collect voice interaction from a user through a terminal and convert collected audio data into text data by using a speech recognition technique; to analyze the text data and item identification information transmitted from the terminal by using a natural language processing technique so as to determine a request and an intention of the user and to retrieve item information including inventory information and related-item information from a data storage device; to associate the determined request and intention of the user with the retrieved item information, to update user profile data and purchase history data, and to generate a prompt sentence for a generative AI model based on the user profile data and the purchase history data so as to cause the generative AI model to generate a response regarding an inventory status and a personalized proposal of related items; to input the generated prompt sentence into the generative AI model and obtain, from the generative AI model, a response text including the inventory status and the proposal of the related items; to transmit the obtained response text to the terminal and cause a visual display device of the terminal to display the response text in real time; to provide an information search function and a schedule management function to the user based on the user profile data and the obtained response text and to store a use history of the functions as part of the purchase history data; and to update contents of future prompt sentences and proposal contents generated by the generative AI model based on the purchase history data and the use history of the information search function. This enables an integrated and technically improved processing pipeline in which user voice input, natural-language understanding, item data retrieval, prompt construction for a generative AI model, response generation, and augmented-reality display are orchestrated by the processor, thereby reducing computational redundancy, improving response relevance and personalization by leveraging unified user profile data and purchase history data, and creating a closed feedback loop in which user interactions continuously refine the internal state used to generate subsequent prompt sentences and system outputs.

The term “processor” refers to one or more hardware processing units, such as a central processing unit, a graphics processing unit, or any other programmable processing circuitry, configured to execute instructions to perform the functions described in the claims.

The term “terminal” refers to a user-side electronic apparatus, such as a mobile computing device, wearable device, or display device, that captures user input including voice input, communicates with the server, and presents information to the user.

The term “voice interaction” refers to an exchange of information between the user and the system in which the user provides spoken utterances that are captured as audio signals and processed by the system.

The term “audio data” refers to digital representations of sound signals, including sampled and encoded waveforms corresponding to a user's spoken utterances.

The term “text data” refers to a sequence of characters or tokens generated by converting audio data or other input data into a machine-readable textual format.

The term “speech recognition technique” refers to a computational method or algorithm that converts audio data representing spoken language into corresponding text data.

The term “natural language processing technique” refers to a computational method or algorithm that analyzes text data in a human language to determine semantics, intent, entities, or other linguistic features useful for understanding and responding to the user.

The term “item identification information” refers to data that uniquely or specifically identifies an item, such as an identifier, code, label, or metadata obtained from a sensor, marker, or user selection.

The term “request and intention of the user” refers to information representing what the user is asking for or trying to achieve, as inferred from the user's input, including a type of operation to be performed and a target item or content.

The term “item information” refers to structured or semi-structured data associated with an item, including, for example, an item's attributes, description, category, price, and availability status.

The term “inventory information” refers to data indicating a current stock status of an item, such as a quantity available, a threshold condition, or an in-stock or out-of-stock state.

The term “related-item information” refers to data describing items that are associated with a given item based on one or more criteria, such as co-purchase patterns, similarity in attributes, or complementary usage.

The term “data storage device” refers to one or more hardware storage components, such as a memory device or persistent storage unit, configured to store data including item information, user profile data, and purchase history data.

The term “user profile data” refers to data representing characteristics or attributes of a user, including preferences, behavioral patterns, historical interactions, or any other information associated with the user that is maintained by the system.

The term “purchase history data” refers to data representing records of past transactions, selections, or interactions of the user with items, including items purchased, items viewed, recommendations accepted, and responses to proposals.

The term “generative AI model” refers to a machine-learned model configured to generate text or other content in response to input data, including a prompt sentence, using statistical or neural network-based methods.

The term “prompt sentence” refers to a text or structured sequence of tokens provided as input to the generative AI model, the text or sequence including instructions, context, and data for guiding the output of the model.

The term “response regarding an inventory status” refers to a portion of a response generated by the system or by the generative AI model that describes the availability, quantity, or stock condition of an item.

The term “personalized proposal of related items” refers to a recommendation or suggestion of one or more related items that is tailored to a specific user based on user profile data, purchase history data, or other user-specific information.

The term “response text” refers to text generated by the generative AI model or by the system that includes at least an inventory status and a proposal of related items and is formatted for presentation to the user.

The term “visual display device” refers to a hardware component configured to present visual information, such as a screen, a head-mounted display, or a projection module, capable of showing the response text to the user.

The term “information search function” refers to a capability of the system to retrieve information from one or more data sources in response to a user's request, including searching databases for item information, user data, or other content.

The term “schedule management function” refers to a capability of the system to manage time-based data for the user, such as events, appointments, reminders, or deadlines, including creation, modification, and retrieval of such data.

The term “use history of the functions” refers to data indicating how and when the user has invoked, utilized, or interacted with the information search function and the schedule management function, including frequency and context of use.

The term “future prompt sentences” refers to prompt sentences that are generated at a time after current processing, where the contents of the prompt sentences are influenced by prior interactions, purchase history data, and use history of the functions.

The term “proposal contents generated by the generative AI model” refers to the substantive recommendation or suggestion portions of the text output by the generative AI model, including recommended items, actions, or options tailored to the user.

The term “preference of the user” refers to tendencies or inclinations of the user toward certain types of items, categories, brands, features, or characteristics as inferred from user profile data and purchase history data.

The term “price tendency” refers to a pattern or range of prices that the user typically selects, accepts, or prefers, as derived from the user's past interactions and purchase history.

The term “co-purchase pattern” refers to a statistical association or correlation between multiple items that are frequently selected, purchased, or interacted with together by one or more users.

The term “candidates of related items” refers to a set of one or more items identified as potentially suitable recommendations based on related-item information, user preference, price tendency, and co-purchase patterns.

The term “rank the candidates according to a priority” refers to assigning an order or score to candidate related items based on predetermined or learned criteria, including relevance to the user and likelihood of acceptance.

The term “augmented-reality display function” refers to a capability of the terminal to superimpose computer-generated visual information onto a user's field of view so that the visual information appears to coexist with a real-world scene.

The term “field of view” refers to an area visible to the user through the visual display device of the terminal, including real-world objects and any virtual overlays presented by the system.

The term “selection operations or additional inputs” refers to user actions, such as gestures, taps, voice commands, or other interaction signals, that indicate a choice, acceptance, rejection, or request for more information regarding displayed content.

In one embodiment, a system includes a server, a terminal, and a user interacting with the terminal in a physical environment such as a retail store. The server implements the functions recited in the claims by using specific hardware and software components, including at least one processor, a main memory, a persistent storage device, and a communication interface connected via a network to the terminal. The terminal includes a microphone, a visual display device such as a head-mounted display or smart glasses, a local processor, and a wireless communication interface.

The server executes a program that is stored on a non-transitory computer-readable medium.

The program is written, for example, in a general-purpose language such as C++, Java, or Python, and is executed on a processor such as a central processing unit and, in some variants, on a graphical processing unit for accelerating neural network inference. The server hosts multiple software modules, including a speech-processing module, a natural-language-understanding module, a data-retrieval module, a recommendation-scoring module, a prompt-construction module, a generative AI interface module, and a response-delivery module. The server further manages at least three database structures: an item database, a user-profile database, and a purchase-history database. In one concrete implementation, the item database is implemented using a relational database management system, the user-profile database is implemented using a document-oriented database, and the purchase-history database is implemented as a time-series store; however, other database technologies may be used.

The terminal runs an application on a mobile operating system such as a smartphone operating system paired with smart glasses, or directly on a smart-glasses operating system. The terminal application controls a microphone, a head-mounted display, and one or more sensors such as a camera or near-field communication reader that provide item identification information. The terminal captures a user's spoken utterances, digitizes the audio using a sampling rate such as 16 kHz with 16-bit resolution, and forwards the audio segments to a speech recognition engine. In one example implementation, the terminal uses a cloud-based speech recognition service, such as a speech-to-text application programming interface, to convert the audio into text data. The terminal associates the resulting text with an item identifier obtained from a barcode, quick-response code, radio-frequency identification tag, or visual object recognition result and transmits this combined data to the server using an encrypted communication protocol.

The server receives the text data and the item identification information and uses a natural language processing engine to analyze the text. In one embodiment, the server uses a neural-network-based model for natural language understanding. The model is a transformer-based architecture comprising multiple self-attention layers, feed-forward layers, layer normalization, and positional encoding. The server represents the text as token sequences and computes contextual embeddings using the transformer layers. From these embeddings, the server derives features such as intent scores (for example, “check inventory,” “compare items,” “request recommendation”) and entity tags (for example, item name, quantity, category) using a classification head implemented as a fully connected neural layer with a softmax activation. The server computes a loss function such as cross-entropy during a prior training phase and updates model weights via gradient descent with an optimizer such as Adam; however, in the deployed system, the model runs in inference mode only.

The server stores user profile data and purchase history data in associated data structures. The user profile data include fields such as preferred categories, preferred price ranges, frequently selected brands, sensitivity to promotions, and interaction style preferences. The purchase history data include entries that associate a user identifier with timestamps, item identifiers, actions taken (viewed, purchased, skipped), and response context (such as inventory state and recommendations presented at that time). The server updates these data structures whenever the user interacts with the system, using an append-only log for purchase events and a summarized profile table for aggregated tendencies. By maintaining these data structures in a normalized and indexed form, the server reduces query time and improves response latency when compiling future recommendations.

The server retrieves item information from the item database using the item identification information sent by the terminal. The item information includes structured fields such as item name, price, category, brand, inventory quantity, and relationships to other items (for example, co-purchase edges, accessory-of relationships). The server may maintain a co-purchase graph, where nodes represent items and edges carry weights representing co-occurrence frequency in past purchase sessions. The server computes related items by traversing this graph and ranking neighbors of the current item according to edge weights, similarity in attributes, and alignment with the user's preferences and price tendency derived from the user profile data and purchase history data.

The server performs recommendation scoring by combining multiple features into a relevance score. Features include item similarity distance in an embedding space (for example, computed by a learned item-embedding model), normalized co-purchase frequency, price deviation from the user's typical range, novelty with respect to the user's past purchases, and recency of popularity indicators. The server calculates a composite score using a weighted sum or a learned ranking function such as gradient-boosted decision trees or a neural ranking model. The server selects the top-ranked related items as candidates of related items and orders them by priority.

The server constructs a prompt sentence for a generative AI model based on the text data, the item information, the user profile data, the purchase history data, and the ranked related items. In one embodiment, the generative AI model is a large-scale transformer-based language model pre-trained on a corpus of text and optionally fine-tuned for dialog and recommendation tasks. The server constructs the prompt by concatenating a system instruction segment, a context segment that encodes the retrieved structured data in a human-readable but structured textual form, and a user-query segment. The server limits the prompt length by applying token counting and truncation rules to avoid exceeding model input limits, and it orders the context fields so that the most important information, such as inventory status and top-ranked related items, appears closest to the end of the prompt, where the model's attention tends to be more focused.

In a concrete example, when the user asks, “Does this product have stock?”, the server constructs a prompt sentence such as:

“The customer asked: ‘Does this product have stock?’

Product information: Product name: Wireless Earphones Model X; Stock quantity: 12; Availability: in stock; Price: 3,000 yen; Category: audio accessories.

### Related Items:

(1) Protective Case for Model X, Price: 800 yen, frequently purchased together with Model X.
(2) Wireless Earphones Model Y, Price: 3,500 yen, same category and similar features.

Customer history summary: The customer often buys mid-priced audio accessories and has previously purchased Wireless Earphones Model W.

Generate a concise, polite in-store response that first answers the stock question clearly and then recommends 1-2 related items that match the customer's preferences.”

In another example, the server constructs a prompt such as:

“Generate a response for a customer who asked: ‘Is this product available in stock?’

Use the following data:
Stock status: in stock, 5 units remaining.

### Related Items:

1) Product B: often bought together, similar price.
2) Product C: higher price, premium quality, same category.

Customer preference: prefers mid- to high-range quality items, often selects premium options.

Provide a short explanation of the stock status and briefly describe the two related items.”

The server transmits the constructed prompt sentence to the generative AI model through a model interface module that manages network calls, authentication, rate limiting, and retry logic. The model runs on dedicated hardware that may include multiple graphical processing units or tensor processing units and uses a multi-head attention architecture, a large number of parameters, and a deep stack of transformer layers. In one learning configuration, the model is pre-trained using an unsupervised objective such as masked language modeling or next-token prediction and fine-tuned using supervised examples of dialog-style responses.

The loss function during fine-tuning can be cross-entropy over next-token distributions, and the model's weights are updated using mini-batch stochastic gradient descent with adaptive learning-rate scheduling. Although such training can be completed prior to deployment, the deployment environment may also support continuous fine-tuning or reinforcement learning from feedback to further adapt the model to domain-specific usage.

The server receives the output tokens from the generative AI model and decodes them into response text. The server constrains generation using decoding strategies such as top-k sampling, nucleus sampling, or beam search, and may enforce length penalties and stop conditions to maintain consistency and readability. The server optionally applies post-processing filters to correct formatting, remove inappropriate content, or normalize item names to match entries in the item database. Because the prompt sentence encodes structured inventory and recommendation context in a consistent, machine-controlled format, the generative AI model operates under a constrained semantic space, which reduces output variance and improves consistency of responses across similar queries.

The terminal receives the response text from the server and uses a rendering module to display the response on the visual display device. In one embodiment, the terminal implements an augmented-reality display function whereby the response text is superimposed within the user's field of view in spatial association with the physical item that the user is observing. The terminal uses pose-estimation and object-detection algorithms to anchor the overlay to the item's position in the environment. The terminal thus controls the position, size, and timing of the displayed content at the display-controller level, which requires specific hardware control beyond a mere abstract presentation of information.

The user sees the inventory status and personalized proposals of related items directly overlaid near the real-world item. The user may perform selection operations or additional inputs, such as focusing gaze on a recommended item, performing a gesture, or issuing a follow-up voice command. The terminal encodes these interactions as structured events including event type, timestamp, selected item identifier, and context, and sends them back to the server. The server records these events in the purchase history data, updates the user profile data to reflect new inferred preferences, and adjusts internal ranking parameters. For instance, if the user repeatedly selects higher-priced alternatives, the server shifts the user's price tendency feature upward and increases weights for premium items in the recommendation scoring module.

This configuration provides several technical effects that improve computer technology beyond simple human task automation. By storing user profile data and purchase history data in optimized data structures and by integrating them with a co-purchase graph and item-embedding representations, the server reduces the amount of redundant computation and network calls required to generate meaningful recommendations. Because the server maintains precomputed embeddings and indices for items, retrieval of related items and computation of relevance scores become efficient, leading to reduced response time.

Additionally, by automatically generating structured prompt sentences that embed only the most relevant item and user context, the server decreases the length of prompts sent to the generative AI model, thereby reducing model inference time and network bandwidth usage.

This reduces overall latency and communication load compared to naive use of generative models that may send large, unstructured context blocks.

The system also improves accuracy and robustness of responses. The natural language understanding module uses a transformer-based architecture with attention mechanisms that capture long-range dependencies in user utterances more effectively than traditional models, thereby improving intent classification and entity extraction accuracy. The alignment of model outputs with structured inventory and recommendation context encoded in the prompt sentence ensures that the generative model's responses are grounded in actual database values, reducing hallucinations and factual errors. The closed-loop update of user profile data and purchase history data allows the system to continuously refine features such as user preference, price tendency, and co-purchase pattern alignment, which improves the precision of recommendation scoring over time.

The server adopts specific non-conventional rules for constructing prompt sentences and controlling the generative AI model's behavior. For example, the server enforces a rule that every prompt sentence must begin with a constrained instruction section encoding the desired style and must include explicit key-value pairs for inventory status and top-ranked related items. This rule is not a human-typical process but a machine-oriented encoding strategy that systematically aligns the internal data structures with the generative model's input space.

This enables deterministic parsing of model outputs and consistent downstream handling. The server may further log pairs of prompt sentences and model outputs along with user acceptance signals, and periodically apply offline training or fine-tuning using a reward-based objective function, where accepted recommendations are considered positive feedback.

In such a case, the server uses a reinforcement learning algorithm, such as policy gradient or proximal policy optimization, to adjust reward-based parameters, thereby improving the generative model's ability to propose items with higher acceptance likelihood.

In some alternative embodiments, the server performs part of the natural language analysis or recommendation scoring on an edge device or gateway to further reduce network latency. In another variation, the terminal locally caches a subset of item and user data so that the augmented-reality overlays can be updated rapidly even when network connectivity is temporarily degraded, with the server performing eventual synchronization of updates. In yet another variation, the generative AI model is hosted on-premises within the same local network as the item database, which reduces round-trip time and allows tighter integration with backend analytics.

In all these embodiments, the system's architecture and operation are directed to specific improvements in computer technology, including shorter and more structured data flows between subsystems, optimized data structures for profile and history data, constrained and efficient prompt sentence construction for generative AI models, and hardware-level control of augmented-reality display to present responses with reduced latency and improved stability. These technical features, acting together, yield measurable improvements in response time, accuracy of inventory and recommendation responses, and reduction in communication load, and they provide an integrated mechanism by which the server, the terminal, and the user cooperate to achieve a functionality that could not be achieved by conventional rule-based systems or by human operators alone.

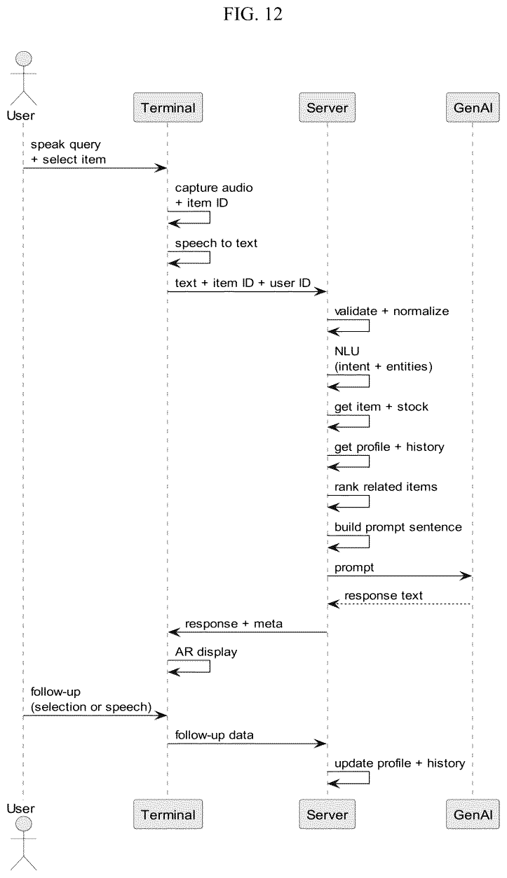

The following describes the processing flow using FIG. 12.

### Step 1

The user provides a voice query and item context to the system.

The user speaks an utterance such as “Does this product have stock?” while looking at or selecting a physical item. The input of this step is the user's spoken audio signal and an implicit or explicit selection of an item (for example, by pointing, scanning a code, or focusing gaze). The output of this step is an analog audio waveform and raw item context (such as a barcode image or tag signal) ready to be captured by the terminal.

### Step 2

The terminal captures audio and item identification information.

The terminal receives the analog voice signal through a microphone and the raw item context through sensors such as a camera, a code reader, or a near-field communication reader. The input of this step is the analog waveform and sensor data. The terminal digitizes the audio into audio data (for example, 16 kHz, 16-bit PCM) and decodes or recognizes the item identifier from the sensor data (for example, by decoding a barcode or recognizing an object in an image). The output of this step is digital audio data and an item identification code.

### Step 3

The terminal performs speech recognition and prepares a request to the server.

The terminal applies a speech recognition technique to the digital audio data, either locally or via a cloud-based speech-to-text service. The input of this step is the digitized audio data. The terminal sends the audio data to a speech recognition engine, which performs feature extraction (for example, Mel-frequency cepstral coefficients), acoustic modeling, and language modeling to output recognized text. The terminal receives text data such as “Does this product have stock?” and combines it with the item identification code and a user identifier. The terminal then packages these as a structured request (for example, a JSON object) and transmits the request to the server over a network connection. The output of this step is a network message containing text data, the item identification code, and user metadata.

### Step 4

The server validates and normalizes the incoming request.

The server receives the request message from the terminal. The input of this step is the structured request containing recognized text, item identification information, and user information. The server validates the structure (for example, checks for required fields, verifies authentication tokens) and normalizes the text (for example, lowercasing, trimming whitespace, standardizing punctuation). The server logs the raw and normalized data into a log store and a request table. The output of this step is a validated and normalized request record, including clean text data, a confirmed item identifier, and a verified user identifier.

### Step 5

The server determines user intent and extracts entities from the text.

The server analyzes the normalized text data using a natural language processing technique, such as a transformer-based intent classification and entity extraction model. The input of this step is the normalized text. The server tokenizes the text, computes contextual embeddings using multiple self-attention layers, and applies a classification head to derive probabilities over possible intents (for example, “check inventory,” “request comparison,” “ask for recommendation”). The server also applies an entity tagging layer to identify entities such as quantity, item references, or temporal expressions. The server selects the highest-probability intent and extracts relevant entities. The output of this step is an internal representation that includes the detected intent, extracted entities, and the associated item identifier.

### Step 6

The server retrieves item information and inventory status.

The server queries an item database based on the item identifier and any entities related to item variants or options. The input of this step is the item identifier and, optionally, extracted entities such as size or color. The server performs a database lookup using an indexed key to obtain item information including name, price, category, brand, attributes, and an inventory quantity. The server calculates the inventory status (for example, in stock, low stock, or out of stock) by comparing the quantity to one or more thresholds. The output of this step is a structured item information record containing detailed attributes and a computed inventory status.

### Step 7

The server retrieves and updates user profile data and purchase history data.

The server accesses user profile data and purchase history data stored in dedicated databases.

The input of this step is the user identifier obtained from the request. The server retrieves profile fields such as preferred categories, typical price range, and brand preferences, and retrieves historical records including viewed items, purchased items, and previously accepted recommendations. The server optionally updates the purchase history data with a new interaction record describing the current query (for example, timestamp, item identifier, intent). The server also updates aggregated features in the user profile data (for example, adjusting average price range if necessary). The output of this step is a set of up-to-date user profile data and purchase history data ready for use in recommendation scoring.

### Step 8

The server computes candidate related items and ranks them.

The server calculates related-item candidates using item relationships and user-specific tendencies. The input of this step is the item information (including relationships such as co-purchase links), the user profile data, and the purchase history data. The server retrieves neighbors of the current item from a co-purchase graph and computes feature vectors for each candidate item, including similarity scores (from an item-embedding model), co-purchase frequencies, price differences relative to the user's typical price range, and novelty relative to previous purchases. The server combines these features using a scoring function (for example, a weighted sum or a ranking model) to produce a relevance score for each candidate. The server sorts the candidates by score and selects the top-ranked items as candidate related items. The output of this step is an ordered list of related items with associated attributes and scores.

### Step 9

The server constructs a prompt sentence for the generative AI model.

The server generates a prompt sentence that encodes the user query, the item information, the inventory status, the ranked related items, and a summary of user preferences. The input of this step is the detected intent, the normalized user text, the structured item information, the inventory status, the ordered related items, and the user profile summary. The server formats these data into a textual structure consisting of: (1) an instruction section indicating style and output requirements, (2) a context section describing item and user data, and (3) a user-query section quoting the original question. The server may truncate or reorder context fields according to priority to keep the prompt within a token budget. The output of this step is a fully constructed prompt sentence suitable for input to the generative AI model.

### Step 10

The server generates a response using the generative AI model.

The server sends the constructed prompt sentence to a generative AI model interface. The input of this step is the prompt sentence. The model processes the prompt by embedding the tokens, applying multiple transformer layers, and predicting successive output tokens via a probability distribution at each decoding step. The server controls decoding with parameters such as temperature, top-k, or nucleus sampling to balance diversity and determinism. The generative model outputs a sequence of tokens, which the server decodes into natural-language text. The server may apply post-processing steps such as truncating excessive length, normalizing item names, or filtering disallowed content. The output of this step is a response text that includes a clear statement of inventory status and a personalized proposal of related items.

### Step 11

The server packages and sends the response to the terminal.

The server encapsulates the generated response text in a response message, together with structured metadata such as item identifiers for recommended items and inventory flags. The input of this step is the response text and associated metadata (for example, IDs and scores of related items). The server formats these into a communication payload and transmits the payload to the terminal over a secure network channel. The server also stores a record of the interaction, including the prompt sentence, the generated response, and any selected recommendations, in the purchase history data for future learning and analysis. The output of this step is a network message arriving at the terminal containing all data necessary for display and interaction.

### Step 12

The terminal renders the response on the visual display device.

The terminal receives the response payload from the server. The input of this step is the response text and any associated metadata such as recommended item identifiers and display layout hints. The terminal parses the payload and passes the response text to a rendering engine. The terminal generates an augmented-reality overlay or on-screen panel that shows the inventory status prominently and lists recommended items with brief descriptions. The terminal may compute overlay positions based on the current field of view and the location of the physical item, using pose and scene data from sensors. The output of this step is a rendered visual display in which the user sees the generated response superimposed in real time.

### Step 13

The user reviews the displayed information and performs a follow-up action.

The user reads the inventory status and the personalized related-item proposals displayed on the terminal. The input of this step is the visual display of the response. Based on this information, the user decides on an action, such as selecting one of the recommended items, asking a follow-up question, or terminating the interaction. The user may perform a gesture, tap on a controller, or speak another utterance (for example, “Tell me more about Product C”). The output of this step is a new user interaction signal (gesture, selection, or voice query) that reflects the user's reaction to the generated response.

### Step 14

The terminal captures the follow-up interaction and notifies the server.

The terminal senses the user's follow-up action through input devices such as touch sensors, motion sensors, or the microphone. The input of this step is the user's selection or new utterance. The terminal encodes the interaction as structured data (for example, selected item identifier, event type, timestamp) and, if the follow-up is spoken, repeats the speech recognition procedure to obtain new text data. The terminal then sends an updated request containing the new text, the selected item identifier (if any), and contextual information about the previous response to the server. The output of this step is a new structured request that continues the dialog and updates the context.

### Step 15

The server updates internal data structures and refines future processing.

The server receives the follow-up request and integrates it into user profile data and purchase history data. The input of this step is the structured follow-up request containing new text data, selected item identifiers, and interaction type. The server records the user's reaction as a labeled outcome (for example, recommendation accepted, ignored, or refined) and updates feature values such as preference scores, price tendency, and co-purchase reinforcement weights. The server may adjust parameters used in recommendation scoring or store new training examples for offline fine-tuning of the generative AI model or the ranking model.

The output of this step is an updated set of internal data structures and parameters that will influence subsequent steps, including future prompt sentence construction and recommendation generation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional conversational assistant systems typically convert user speech into text and perform shallow intent detection or keyword matching to return pre-defined responses or search results. Such systems are limited in several important respects from a computer-technology standpoint. First, these systems generally treat each utterance as an isolated input and do not maintain a structured, machine-usable user profile that integrates both semantic content (requests, intentions, interests, wishes, concerns, regrets) and dynamically recognized emotional states over time. As a result, the underlying data structures and processing pipelines of the computer system do not effectively capture longitudinal user context, which leads to low-quality personalization and inefficient use of computational resources for repeated analysis of similar inputs.

Second, existing systems typically invoke machine learning models or rule-based engines in a monolithic way, without a clear separation between (i) analysis of the user's current state and (ii) generation of personalized content. This lack of separation prevents optimization of model inputs and outputs for each distinct stage, causes redundant or noisy prompts, and makes it difficult to control generative models in a reliable and safety-conscious manner. In particular, there is no systematic mechanism in the computer architecture to construct and manage different classes of prompt sentences (for analysis and for proposal generation) based on continuously updated user profile data. Consequently, generative models may produce inconsistent or inappropriate outputs, and the system cannot efficiently reuse prior analysis to reduce latency and processing load.

Third, conventional systems rarely incorporate structured emotional-state recognition into the control logic of user-facing responses and third-party messaging. Even when emotion detection is performed, it is often used only to label the interaction rather than to adjust subsequent system behavior at the processing level. There is no integrated, processor-level method that uses recognized emotional states together with stored profile data to (i) adjust real-time responses on the user terminal and (ii) automatically generate and route messages or proposals to related parties, in a way that is governed by explicit machine-executable rules and data flows. This leads to a computer system that is functionally limited, difficult to scale, and unable to systematically handle sensitive communications. Accordingly, there is a need for an improved computer-implemented system that: (1) structurally models and updates user profile data combining semantic attributes and emotional states; (2) programmatically constructs and manages staged prompt sentences to control a generative AI model for both analysis and personalized proposal generation; and (3) automatically coordinates real-time user responses and indirect messaging to related parties in a way that improves the technical functioning of the conversational assistant platform, including data structures, control flow, and model interaction protocols.

The specific processing by the specific processing unit 290 of the data processing device 12 in Example 2 is realized by the following means.

The present invention provides a server comprising a processor and associated memory storing instructions which, when executed by the processor, cause the server to acquire a voice interaction with a user via an acoustic input-output function of a terminal and convert acquired voice information into character information using a speech recognition technique; analyze the character information using a natural language processing technique to extract information on a request, intention, interest, wish, concern, or regret of the user and classify a basic emotion shown by the user into an emotional state; associate the extracted information with the recognized emotional state as profile information of the user, store the profile information in an information storage device, and update and manage the profile information over time in a structured, machine-readable format; generate, based on the profile information and the character information, a first prompt sentence that instructs a generative AI model having a generative processing function to generate content that gently conveys an awareness of the user to a related party associated with the user or to generate a personalized proposal according to the emotional state or the interest of the user, and input the first prompt sentence to the generative AI model so as to cause the generative AI model to generate a message or a proposal to the related party; generate, using the stored voice interactions, character information, profile information, and past response history, an analysis prompt sentence and a proposal-generation prompt sentence in staged fashion and control input to and output from the generative AI model so that analysis of a user need and generation of personalized service content are automatically executed; transmit the generated message or proposal indirectly, via a communication network, to an information terminal used by the related party other than the user; adjust a response content to the user based on the recognized emotional state and the profile information of the user; and present the adjusted response content sequentially and in real time via a display output or a voice output of a user terminal.

This enables the computer system to implement an improved conversational processing pipeline that maintains a rich, dynamically updated user profile, orchestrates distinct analysis and generation phases via structured prompt sentences to a generative AI model, and coordinates personalized real-time responses and indirect third-party messaging, thereby enhancing the technical performance, control, and reliability of the underlying information processing architecture.

The term “voice interaction” refers to an exchange of information between a user and a system through spoken utterances captured as audio signals.

The term “acoustic input-output function” refers to a hardware and software capability of a terminal for capturing sound via a microphone and presenting sound via a speaker or equivalent audio transducer.

The term “terminal” refers to a user-side computing device, such as a mobile device, a handheld device, or a personal computing device, that includes an interface for communication with a server.

The term “voice information” refers to digital audio data representing spoken input from a user, obtained by sampling acoustic signals.

The term “character information” refers to text data obtained by converting voice information into a sequence of characters using a speech recognition technique.

The term “speech recognition technique” refers to a computerized process or algorithm that analyzes voice information and outputs corresponding character information representing recognized words or phrases.

The term “natural language processing technique” refers to a computerized process or algorithm that analyzes character information to detect linguistic features, semantic content, and contextual meaning.

The term “request” refers to an expressed demand, query, or desired action communicated by the user to the system.

The term “intention” refers to an underlying purpose, goal, or plan inferred from the user's utterance as determined by analysis of character information.

The term “interest” refers to a topic, category, or area toward which the user exhibits a preference or curiosity, as inferred from user interactions.

The term “wish” refers to a desired state or outcome that the user expresses or implies through spoken or textual input.

The term “concern” refers to a problem, anxiety, issue, or difficulty expressed or implied by the user in relation to their circumstances.

The term “regret” refers to a negative evaluation by the user regarding a past action, event, or omission, expressed or inferred from the user's utterance.

The term “basic emotion” refers to a fundamental emotional category, such as joy, anger, sadness, or surprise, recognized by analyzing user behavior or speech.

The term “emotional state” refers to a classification result indicating the current or recent emotion of the user based on detected basic emotions.

The term “profile information” refers to structured data describing attributes of a user, including at least requests, intentions, interests, wishes, concerns, regrets, and emotional states, stored for use in subsequent processing.

The term “information storage device” refers to a hardware component or subsystem, such as a memory device or a storage medium, configured to store digital data including profile information.

The term “generative processing function” refers to a capability of a computational model to produce new text, content, or data outputs in response to input information.

The term “generative AI model” refers to a machine learning model trained on data to generate content, such as text, based on input prompts and learned patterns.

The term “prompt sentence” refers to a structured text input provided to a generative AI model that specifies instructions, context, and constraints for generating an output.

The term “first prompt sentence” refers to a prompt sentence constructed using current character information and profile information of the user to instruct a generative AI model to generate content for a related party or a personalized proposal.

The term “analysis prompt sentence” refers to a prompt sentence designed to cause a generative AI model to analyze user inputs and profile information for the purpose of extracting needs, states, or structured attributes.

The term “proposal-generation prompt sentence” refers to a prompt sentence designed to cause a generative AI model to generate recommendation content, messages, or proposals tailored to the user or a related party.

The term “related party” refers to an individual or entity associated with the user, such as a family member, acquaintance, or other relevant person, who can receive messages or proposals generated by the system.

The term “message” refers to generated content expressed in natural language that is intended to be presented to the user or a related party.

The term “proposal” refers to generated recommendation content, including suggestions or options, tailored to the user's state, interests, or circumstances.

The term “communication network” refers to an interconnected set of communication links and nodes, such as a wired or wireless data network, that enables data transmission between a server and terminals.

The term “information terminal” refers to a computing device operated by a related party, configured to receive and present messages or proposals transmitted by the server.

The term “response content” refers to information, including text or audio, that is generated by the system and provided to the user in reply to a user interaction.

The term “display output” refers to a visual presentation of information on a screen or visual display unit of a terminal.

The term “voice output” refers to an audible presentation of information generated as synthesized speech or played audio through a speaker of a terminal.

The term “information retrieval function” refers to a capability of the system to search for and obtain data relevant to a user's request from one or more data sources.

The term “action planning management function” refers to a capability of the system to create, update, and manage schedules, tasks, or planned activities for a user.

The term “past response history” refers to stored records of prior outputs or interactions generated by the system and presented to the user or related parties.

The term “input control” refers to operations performed by the processor to construct, select, and supply appropriate prompt sentences and associated data to a generative AI model.

The term “structuring processing of an output result” refers to operations performed by the processor to parse, format, and organize data generated by a generative AI model into a structured representation usable by other components of the system.

The term “personalized service content” refers to information, messages, or proposals that are adapted to specific attributes, preferences, or emotional states of an individual user.

In one embodiment, a server cooperates with a terminal operated by a user to implement a personalized conversational assistance system. The server includes at least one processor, a memory, a network interface, and a non-transitory storage device. The terminal includes at least one processor, a memory, an audio input-output module including a microphone and a speaker, a display, and a network communication module.

The terminal uses an operating system audio API, such as an audio recording interface provided by a mobile operating system, to capture acoustic signals corresponding to the user's voice. The terminal digitizes the acoustic signals as pulse code modulated audio frames with a predetermined sampling rate and bit depth, and stores the audio frames in a buffer in memory. The terminal uses a communication library, such as an HTTP client stack, to send the buffered audio frames together with metadata including a user identifier and a timestamp to the server via a packet-based communication network.

The server receives the audio frames through the network interface and stores the frames temporarily in a file system or in a binary large object field in a storage device. The server uses a speech recognition engine, such as a cloud-based speech-to-text service or an on-premises acoustic-linguistic model, to convert the audio frames into character information.

The server supplies the digitized audio, sampling parameters, and a language specification to the speech recognition engine, which applies an acoustic model and a language model to produce a sequence of textual tokens. The server receives character information as a string sequence and normalizes the sequence by applying operations such as whitespace trimming, punctuation standardization, and tokenization using a natural language processing library.

The server applies a natural language processing pipeline to the normalized character information to extract semantic elements for profile construction. The server uses a tokenizer, a part-of-speech tagger, and a dependency parser, such as components available in a general-purpose NLP framework, to segment the text into tokens and to annotate syntactic roles. The server identifies candidate expressions related to requests, intentions, interests, wishes, concerns, and regrets, using rule-based patterns and statistical classifiers trained on annotated conversational data. The server also computes features indicative of emotional state, including lexical features, prosodic features if available from the speech recognition output, and contextual features from previous utterances stored in a conversation history.

The server uses a generative AI model to perform higher-level semantic and emotional analysis as well as content generation. In one implementation, the generative AI model is a transformer-based neural network with multiple self-attention layers, feed-forward layers, and positional encoding structures. The server maintains model parameters in a model storage area and executes the model on a computation subsystem such as a graphics processing unit or a tensor accelerator. The generative AI model is trained using a corpus of conversational data with supervised labels for user intents, interests, and emotional states, and with training examples of empathetic responses and proposals. During training, the server uses a cross-entropy loss function to compare predicted token sequences or predicted labels against ground truth labels. The server updates model weights by applying gradient-based optimization, such as stochastic gradient descent with adaptive learning rate. The server may apply data augmentation techniques such as paraphrasing, synonym substitution, and noise injection in the input text to improve generalization.

The server constructs prompt sentences as structured text instructions to the generative AI model. The server differentiates between analysis prompt sentences and proposal-generation prompt sentences. The server uses an internal template engine to assemble prompt sentences from stored template fragments and current data values. The server stores the templates in a configuration database and dynamically replaces placeholder tokens with actual character information, profile attributes, and context identifiers. For example, the server may generate an analysis prompt sentence of the following form:

System: You are a generative AI model that extracts user intent, interests, and emotion from text.

User utterance: “Lately I have been thinking that I really want to travel somewhere.”

Task: Analyze the utterance and respond with the following items:
intent: a short phrase describing what the user wants to do,
interests: a list of topics relevant to the user,
emotion: a single word describing the user's emotional state,
confidence: a numerical score between 0.0 and 1.0.

Only output the four items in plain text labels and values.

The server sends this analysis prompt sentence and the user's utterance as input tokens to the generative AI model. The server encodes the prompt sentence into token identifiers via a tokenizer consistent with the model's vocabulary. The generative AI model processes the token sequence through its layers, computing attention scores between all token positions and generating a representation vector for each token. The final layer computes probability distributions over output tokens conditioned on the input and previously generated tokens.

The server decodes the model's output token sequence and parses the result to extract structured values for intent, interests, emotion, and confidence.

The server stores the extracted values in a profile data structure. The profile data structure is implemented, for example, as a normalized relational schema including a user table, an interest table, an emotion history table, and an interaction table. The server associates each extracted interest with a canonical topic identifier and stores it in the interest table with a timestamp. The server appends an entry to the emotion history table including the recognized emotional state and a confidence score, and links this entry to the corresponding interaction.

The server updates summary fields in the user table, such as dominant interests and typical emotional patterns, by applying aggregation functions over the history. This structured storage enables efficient indexing and retrieval operations, reduces duplication of analysis for recurrent patterns, and supports optimized query execution by the database engine.

The server then constructs a proposal-generation prompt sentence using the profile information and the latest utterance. The server combines fields such as interests, emotional state, and previously accepted proposals to form a context block, and attaches a generation instruction block that specifies the format and content of the expected proposal. For example, the server may generate a proposal-generation prompt sentence of the following form: System: You are a generative AI model acting as a personal travel assistant.

User profile: interests=[travel, vacations], emotional_state=excited, budget=medium, preferred_travel_style=relaxed sightseeing.

Latest user utterance: “Lately I have been thinking that I really want to travel somewhere.”

Task: Generate three specific trip suggestions that match the user's profile and current intent.

For each suggestion, provide:
a title,
a destination,
a short description,
a reason why it fits the user's profile and emotional state.

Write the suggestions in concise English prose suitable for display in a mobile application.

The server encodes this proposal-generation prompt sentence and feeds it to the generative AI model, which produces textual suggestions. The server parses the output text into structured fields using pattern recognition and delimiter tags inserted in the template. The server may apply rule-based validation to ensure that each suggestion contains all required elements and that the content complies with safety and appropriateness constraints. The server then formats the validated suggestions in a response message to be transmitted to the terminal.

The server uses the recognized emotional state together with the user's interaction history to adjust the style and timing of responses. The server implements a response-tuning module that maps emotional state values and profile attributes to presentation parameters, such as verbosity, level of detail, and degree of directness. For example, when the emotional state indicates high stress or sadness, the server selects templates that use softer wording and longer explanatory phrases. The server stores these mappings as rules in a configuration table and executes them as part of the response construction logic, which constitutes a machine-executable rule set independent of human operator judgment.

The terminal receives the server's response through the network communication module. The terminal parses the response payload and renders the personalized service content on the display as textual cards, lists, or dialog messages. The terminal can additionally pass the textual content to a text-to-speech engine, such as an operating system speech synthesis service, to generate audio signals that drive the speaker. By controlling the audio playback parameters, such as volume and speaking rate, the terminal ensures that the user perceives the personalized suggestions in a comfortable and consistent manner.

The server also controls indirect messaging to related parties. When the profile information and the analysis prompt sentence indicate that the user has expressed a wish, concern, or regret that is appropriate to share with a related party, the server includes related-party identification data in the first prompt sentence. The generative AI model receives instructions to generate a message that gently and empathetically conveys the user's awareness to the related party. The server then determines an appropriate destination terminal for the related party and transmits the generated message via the communication network. The server logs the delivery and optionally records acknowledgment information returned from the related party's terminal.

The server improves computer-implemented processing in several ways. By separating analysis prompt sentences from proposal-generation prompt sentences and by structuring these prompts according to user profile data, the server reduces the length and redundancy of each model invocation. This separation reduces the computational load on the generative AI model, as the model can reuse analysis outputs and does not need to infer the complete context for each generation. The server also improves data management by storing profile information in structured relational tables, enabling efficient indexing and query optimization that reduce latency when retrieving user context. The use of staged processing and structured prompts allows the server to reduce the number of model calls per interaction, thereby lowering communication overhead between the server and any external model provider.

The server implements non-conventional processing steps in constructing and using prompt sentences. Instead of directly forwarding raw user utterances to a model, the server performs controlled feature extraction, profile-based context building, and template-driven prompt generation. These operations constitute specific algorithmic steps that modify the way data is prepared and passed to the generative AI model, improving both accuracy and stability of the outputs compared to generic conversational systems. The server further applies rule-based post-processing of model outputs to enforce structural constraints and to integrate generated content into existing data structures, thereby reducing errors and inconsistent responses.

The generative AI model in this system uses a neural network architecture that is trained with explicit objectives related to intent extraction and empathetic response generation. The server defines loss functions that combine sequence prediction error with classification error for emotional states. During training, the server adjusts model parameters according to gradient signals computed for both tasks. This multi-task training improves the model's ability to produce coherent and emotionally appropriate content. The server may employ curriculum learning strategies, where simpler tasks such as basic intent recognition are learned first, followed by more complex tasks such as generating nuanced messages to related parties. By carefully designing the training procedure and loss functions, the server achieves improved accuracy in both internal analysis and user-facing generation.

The system provides technical effects that go beyond mere automation of human conversation. The structured profile data and staged prompt construction enable the server to reduce redundant computations and to reuse contextual information efficiently. This leads to faster response times and lower resource consumption. The emotion-aware response tuning module exploits machine-readable emotional states not only for labeling, but for dynamic control of how and when responses are generated and presented, resulting in reduced user confusion and fewer repeated queries. The combination of rule-based feature extraction, template-based prompt generation, and model-based content generation leads to improved precision in understanding user needs and in generating appropriate proposals.

In another embodiment, the server deploys multiple generative AI models specialized for different domains, such as travel, health information, or education. The server selects a domain-specific model based on profile attributes and extracted intent. The server constructs domain-specific prompt sentences that reference specialized ontologies or controlled vocabularies for each domain. For example, for a health-related concern, the server uses templates that require the model to emphasize safety and to include disclaimers. This modular architecture enhances both the flexibility and technical reliability of the system, as each model can be optimized for its specific task while sharing the same profile and prompting infrastructure.

In yet another embodiment, the server maintains a local inference engine for on-device or on-premises deployment. The server loads a quantized version of the generative AI model optimized for limited hardware resources. The server adjusts batch sizes, sequence lengths, and caching strategies for attention computations to minimize latency. This configuration enables deployment in environments with restricted network connectivity while preserving the structured profile management and staged prompt mechanisms described above.

Through these embodiments, the server, terminal, and user cooperate in a concrete technical arrangement that uses specific data structures, neural network architectures, and processing rules to achieve improved conversational assistance. The described system thus provides a practical implementation of the claimed invention that can be realized using general-purpose computing hardware combined with specialized software modules including speech recognition engines, natural language processing libraries, and generative AI models controlled via structured prompt sentences.

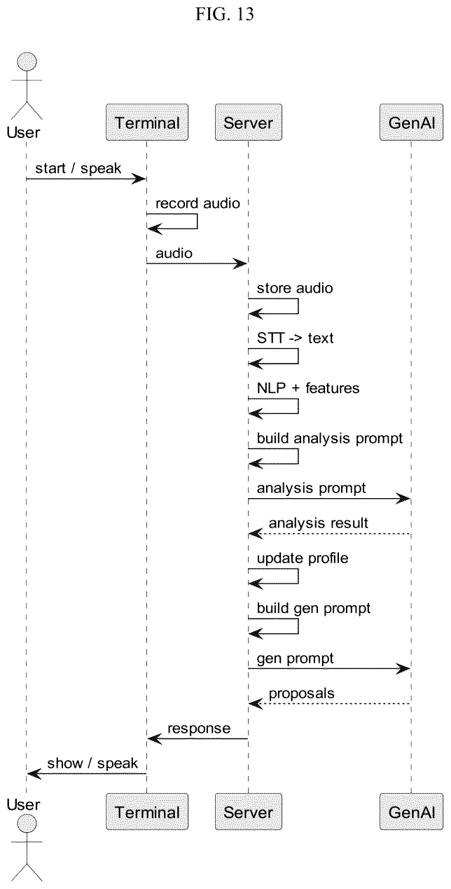

The following describes the processing flow using FIG. 13.

### Step 1

User initiates an interaction with the system.

User operates the terminal to start an application and activates a voice interaction function, for example by tapping a button or speaking a wake word.

Input: No digital data is required as input to this step; the trigger is a user action on the terminal.

Output: The terminal enters a listening state and prepares internal buffers and configuration parameters (sampling rate, bit depth, language code) for subsequent audio capture.

### Step 2

Terminal captures and digitizes the user's voice.

Terminal activates a microphone via an operating system audio API and samples the acoustic signal at a fixed sampling rate (for example, 16 kHz, 16-bit mono).

Terminal segments the continuous audio stream into frames and stores the frames in a circular buffer in memory until the user stops speaking or silence is detected.

Input: Analog acoustic signal generated by the user's speech.

Data processing: Terminal converts the analog signal into digital pulse-code-modulated audio samples, timestamps each frame, and may perform simple preprocessing such as noise reduction or gain control.

Output: A sequence of digital audio frames representing the user's utterance and associated metadata such as user identifier, device identifier, and timestamps.

### Step 3

Terminal sends the audio data to the server.

Terminal packages the audio frames and metadata into a request message formatted according to a communication protocol (for example, HTTP over TLS) and transmits the message through a network interface.

Input: Digital audio frames and metadata stored in the terminal's memory.

Data processing: Terminal serializes the audio data into a binary or compressed encoding (for example, linear PCM in a container format), constructs headers including content type and user identifier, and encrypts the payload if necessary.

Output: A network data packet stream delivered to the server's network interface.

### Step 4

Server receives and stores the raw audio data.

Server listens on an application endpoint and accepts incoming requests containing audio data.

Server validates the request, extracts the audio payload and metadata, and writes the raw audio bytes to a temporary storage location in a file system or binary storage table.

Input: Serialized audio stream and metadata received via the communication network.

Data processing: Server parses protocol headers, checks integrity and format of the audio data (sample rate, bit depth, duration constraints), and assigns a unique identifier for the audio session.

Output: A stored audio object referenced by an internal session identifier and a record in a session management table.

### Step 5

Server converts audio data into character information using a speech recognition technique.

Server sends the stored audio object to a speech recognition engine with configuration parameters such as language and punctuation options.

The speech recognition engine executes acoustic and language modeling to produce a textual transcription.

Input: Audio session identifier and corresponding stored digital audio data.

Data processing: Server invokes a speech recognition API, which applies feature extraction (for example, Mel-frequency cepstral coefficients), acoustic modeling, and decoding algorithms (for example, beam search) to map the audio sequence to a text sequence.

Output: Character information representing the transcription of the user's utterance and an associated confidence score, stored as a text string and numeric values.

### Step 6

Server normalizes and tokenizes the character information.

Server applies text normalization procedures including trimming whitespace, standardizing punctuation, and converting special characters to canonical forms.

Server tokenizes the normalized text into units such as words and punctuation marks using a natural language processing library.

Input: Raw transcription text and confidence values from the speech recognition engine.

Data processing: Server executes string operations and tokenization algorithms to convert the raw string into a list of tokens and to mark sentence boundaries.

Output: A normalized text string and a token sequence with positional indices, ready for semantic analysis.

### Step 7

Server performs initial semantic and emotional feature extraction.

Server uses linguistic analysis tools such as part-of-speech tagging and dependency parsing to annotate each token with grammatical roles and relationships.

Server applies pattern-matching rules and trained classifiers to identify candidate phrases indicating requests, intentions, interests, wishes, concerns, and regrets.

Server computes emotion-related features, such as sentiment polarity and intensity scores, based on lexical markers and contextual usage.

Input: Token sequence, normalized text string, and any available contextual metadata (for example, previous interaction identifiers).

Data processing: Server executes tagging algorithms and rule-based filters to map tokens to semantic categories and computes feature vectors representing content categories and emotional indicators.

Output: An intermediate structured representation including annotated tokens, candidate semantic labels, and numeric feature vectors for emotion estimation.

### Step 8

Server constructs an analysis prompt sentence for a generative AI model.

Server retrieves relevant user profile information, such as prior interests and typical emotional patterns, from a database using the user identifier.

Server combines the normalized text, extracted features, and profile data into a structured instruction text according to a pre-defined template.

Input: Normalized text, intermediate structured representation, and stored user profile records.

Data processing: Server fills placeholder fields in an analysis template with the current utterance, a description of the analysis task, and any necessary constraints on the output format.

Output: An analysis prompt sentence in natural language that instructs the generative AI model to extract intent, interests, and emotional state.

### Step 9

Server analyzes the user's intent, interests, and emotional state using the generative AI model.

Server encodes the analysis prompt sentence into input tokens compatible with the generative AI model and forwards these tokens to a neural network engine.

The generative AI model computes hidden representations and generates output tokens corresponding to a structured analysis result.

Input: Analysis prompt sentence and associated encoded token sequence.

Data processing: Server performs a forward pass through a transformer-based neural network, which applies multi-head self-attention and feed-forward layers to propagate information across the token sequence, and then decodes the output tokens into a human-readable analysis.

Output: A textual analysis result containing explicit labels for user intent, list of interests, emotional state, and optional confidence scores.

### Step 10

Server parses and structures the analysis result.

Server applies pattern recognition or regular expression parsing to extract values from the textual analysis produced by the generative AI model.

Server converts the extracted values into well-defined data fields consistent with the profile schema, such as intent_code, interest_list, emotion_label, and confidence_value.

Input: Textual analysis output returned by the generative AI model.

Data processing: Server removes auxiliary text, splits lines or segments based on separators, and maps recognized labels to structured fields using a predefined mapping table.

Output: A structured analysis object containing typed fields for user intent, interests, and emotional state.

### Step 11

Server updates the user's profile information in a storage device.

Server uses the structured analysis object and the user identifier to generate database commands that insert or update profile records.

Server writes new interests, emotional states, and recent intents to appropriate tables and maintains timestamped history records.

Input: Structured analysis object and user identifier.

Data processing: Server executes database operations such as INSERT and UPDATE statements to record new data and to aggregate or overwrite summary fields in the profile.

Output: An updated profile record set that reflects the latest user state and a confirmation of successful storage operations.

### Step 12

Server constructs a proposal-generation prompt sentence for the generative AI model.

Server retrieves the updated profile information, including dominant interests, recent emotional states, and previously generated proposals that were accepted or declined.

Server composes a generation instruction text that describes the type, number, and style of proposals to be generated.

Input: Updated user profile records and normalized text of the latest utterance.

Data processing: Server blends the profile attributes and the latest utterance into a domain-specific prompt template, specifying required output elements such as titles, descriptions, and justifications.

Output: A proposal-generation prompt sentence that directs the generative AI model to create personalized service content.

### Step 13

Server generates personalized proposals using the generative AI model.

Server encodes the proposal-generation prompt sentence into tokens and submits them to the generative AI model for a forward generation pass.

The generative AI model produces a sequence of tokens representing multiple proposals, each including descriptive information and reasons why it matches the user's profile.

Input: Proposal-generation prompt sentence and corresponding token sequence.

Data processing: Server executes the generative phase of the neural network, sampling or selecting tokens from probability distributions output by the model while enforcing constraints such as maximum length and avoidance of disallowed phrases.

Output: A textual set of personalized proposals formatted as natural language paragraphs or bullet points.

### Step 14

Server validates and structures the generated proposals.

Server checks that each proposal includes the required elements (for example, title, description, reason) and that the content conforms to safety and appropriateness rules stored in configuration data.

Server converts the proposals into structured records for inclusion in a response object.

Input: Raw textual proposals produced by the generative AI model.

Data processing: Server applies parsing rules and validation checks, discarding or modifying proposals that do not meet constraints and tagging each with metadata such as source model and generation time.

Output: A structured proposal set suitable for transmission to the terminal and optional storage for audit purposes.

### Step 15

Server adjusts response content based on emotional state and profile data.

Server reads the current emotional state and relevant profile attributes, and selects response templates that specify tone, level of detail, and presentation order.

Server applies these templates to the structured proposal set to generate a final response text that is consistent with the user's emotional condition.

Input: Structured proposal set, emotional state label, and profile attributes.

Data processing: Server evaluates rule-based mappings from emotional states to template configurations and applies text transformation operations such as rephrasing, adding empathetic prefaces, or simplifying explanations.

Output: A finalized response payload including text content, presentation hints, and references to generated proposals.

### Step 16

Server transmits the personalized response and any related-party message.

Server encapsulates the finalized response payload in a message formatted according to the communication protocol and sends it to the user's terminal.

If a related-party message is indicated by the analysis, the server similarly encapsulates and transmits the message to a terminal associated with the related party.

Input: Finalized response payload for the user and optional related-party message content.

Data processing: Server serializes the payloads, attaches routing information such as device identifiers and endpoint addresses, and sends them over the communication network.

Output: Network data packets carrying the user response and, when applicable, an indirect message to a related party's terminal.

### Step 17

Terminal receives and presents the response to the user.

Terminal receives the response message from the server, parses the payload, and extracts the proposals and any presentation instructions.

Terminal renders the proposals on the display as interactive elements and may invoke a text-to-speech engine to produce audio output through the speaker.

Input: Serialized response payload from the server.

Data processing: Terminal decodes the message, maps structured fields to user interface components (for example, cards or list items), and schedules display updates and audio playback according to instructions and local user settings.

Output: Visual and/or auditory presentation of personalized service content to the user, enabling the user to read, listen to, and act upon the generated proposals.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional conversational systems and so-called virtual assistants typically convert user speech to text and perform intent recognition to return predefined answers or execute simple commands. However, these systems suffer from several technical limitations in how they process, store, and utilize user state information at scale.

First, conventional systems generally treat each utterance as an isolated command and do not construct or maintain a structured, machine-processable user profile that consistently links extracted semantic information (for example, user requests, interests, wishes, worries, regrets) with fine-grained emotional states over time. As a result, the systems are unable to perform context-aware processing that leverages long-term dialogue history and behavioral history. This limits the accuracy and stability of downstream tasks such as personalized content generation, recommendation, and notification.

Second, although some systems apply sentiment analysis or simple polarity detection, they do not technically integrate multi-dimensional emotion classification and profile updating into a unified processing pipeline that can be programmatically exploited to generate prompt sentences for a generative AI model. Consequently, large-scale language models are often invoked with ad hoc or manually crafted prompts that do not systematically encode the user's current emotional state, historical patterns, or inferred needs. This leads to inconsistent output quality, difficulties in reproducibility, and increased computational overhead due to repeated, context-free model calls.

Third, existing architectures do not provide a computer-implemented mechanism for generating and delivering indirect, considerate messages to related parties (for example, family members or other associated persons) based on the user's profile and emotional state, while simultaneously adjusting responses to the user in real time. In many implementations, any communication to related parties is either manual or based on simple event triggers (for example, calendar reminders), without leveraging a shared, structured profile or dynamically generated prompt sentences. This results in under-utilization of available data and suboptimal support for complex, multi-recipient interaction scenarios.

Fourth, current systems typically separate “assistant functions” such as information search and schedule management from higher-level generative functions. There is no unified computational framework that combines (i) speech-to-text conversion, (ii) natural language understanding, (iii) emotion analysis, (iv) long-term profile construction, (v) generation of structured prompt sentences for generative AI models, and (vi) controlled message delivery paths for both the user and related parties. This fragmentation causes redundant processing, inconsistent state between modules, and increased latency, and makes it technically difficult to scale and maintain the system.

Accordingly, there is a need for an improved computer-implemented system that:
(1) acquires user speech and robustly transforms it into structured text and emotional state data;
(2) builds and maintains profile data that associates extracted semantic information with classified emotional states and historical behavior;
(3) automatically constructs prompt sentences for a generative AI model based on this profile data and current dialogue context;
(4) generates indirect, personalized messages or proposals for related parties and adjusts real-time responses to the user; and
(5) integrates these capabilities with information resource search and schedule management functions in a technically coherent processing architecture. Such a system would improve the efficiency, consistency, and technical performance of conversational computing environments, beyond merely implementing a business or communication method.

The specific processing by the specific processing unit 290 of the data processing device 12 in Application Example 2 is realized by the following means.

The present invention provides a server comprising a processor and a memory storing instructions which, when executed by the processor, cause the server to acquire audio data representing spoken input from a user and record the audio data as digital audio data; convert the digital audio data into text data by using a speech recognition technique; apply a natural language processing technique to the text data to perform sentence structure analysis, phrase extraction, and intent classification, and thereby generate extracted information regarding a request and an intention of the user and regarding interests, wishes, worries, or regrets held by the user; apply an emotion analysis technique to the text data to calculate emotion scores for a plurality of emotions including joy, anger, sadness, and surprise, and classify and recognize an emotional state of the user based on the emotion scores; store the extracted information and the emotional state as profile data associated with user identification information in a database and update the profile data by integrating the extracted information and the emotional state with past dialogue history and purchase history; generate, based on the profile data and current dialogue content, a prompt sentence for input to a generative AI model, the prompt sentence including summary information regarding the request, the intention, the interests, the wishes, the worries, or the regrets of the user and summary information regarding the emotional state of the user; transmit the generated prompt sentence to the generative AI model and obtain generated text from the generative AI model, the generated text including at least one of a message that indirectly communicates an awareness of the user to a related party other than the user and a personalized proposal corresponding to the emotional state or the interests of the user; extract content of the message or the proposal from the generated text and indirectly transmit the message or the proposal, via a communication function, to an information processing terminal of the related party other than the user; adjust an expression style, a tone, or an amount of information of response content to be presented to the user based on the generated text and the emotional state of the user, and present the adjusted response content to the user in real time via a display unit or an audio output unit of an information processing terminal of the user; and execute an information resource search function and a schedule management function based on the text data and the profile data and present search result information and schedule information to the information processing terminal of the user. This enables a technical improvement in computer-implemented conversational processing by unifying speech recognition, natural language understanding, emotion analysis, long-term profile management, automatic construction of prompt sentences for a generative AI model, and controlled multi-recipient message delivery in a single processing pipeline, thereby enhancing consistency of system state, reducing redundant computation, improving the relevance and stability of generated outputs, and supporting context-aware real-time interaction with both the user and related parties.

The term “audio data” refers to time-series data representing acoustic signals originating from spoken input of a user, which is captured by an input device such as a microphone and is processable by a computing device.

The term “digital audio data” refers to audio data that has been converted into a discrete, digitized format, including sampled and quantized values, suitable for storage, transmission, and processing by a computing device.

The term “speech recognition technique” refers to a computational method or algorithm that analyzes digital audio data and converts the data into corresponding text data representing recognized words and phrases spoken by a user.

The term “text data” refers to a sequence of characters or tokens representing linguistic content derived from user speech or other input, which is processable by natural language processing techniques.

The term “natural language processing technique” refers to a set of algorithms or models that operate on text data to perform linguistic analysis, including at least one of tokenization, sentence boundary detection, part-of-speech tagging, syntactic parsing, semantic analysis, and intent classification.

The term “sentence structure analysis” refers to processing that identifies grammatical relationships between words or tokens in text data, including syntactic roles and dependency relationships, to obtain a structural representation of at least one sentence.

The term “phrase extraction” refers to processing that identifies and selects relevant word sequences or expressions from text data, including key phrases indicative of user requests, interests, wishes, worries, or regrets.

The term “intent classification” refers to processing that categorizes text data into one or more predefined intent classes indicating a purpose of a user utterance, such as requesting information, seeking a recommendation, or expressing an emotional state.

The term “extracted information” refers to structured data derived from text data by natural language processing techniques, including at least one of user requests, intentions, interests, wishes, worries, or regrets.

The term “emotion analysis technique” refers to a computational method or model that evaluates text data or other user-related data to determine one or more emotional attributes, such as joy, anger, sadness, or surprise, and outputs scores or labels representing an emotional state.

The term “emotion score” refers to a numerical value or a set of numerical values indicating a likelihood, intensity, or degree of at least one emotion inferred from user-related data.

The term “emotional state” refers to a classification result that represents one or more emotions associated with a user at a particular time, derived from emotion scores or other emotion analysis outputs.

The term “profile data” refers to data stored for a particular user that associates extracted information and emotional states with user identification information and optionally includes past dialogue history, purchase history, behavior history, and event information.

The term “user identification information” refers to data that uniquely or pseudo-uniquely identifies a user within a system, such as an identifier, account information, or a token.

The term “database” refers to a structured data storage system managed by a computing device, which supports storing, retrieving, and updating data items including profile data.

The term “dialogue history” refers to stored records of past interactions between a user and a system, including at least prior utterances, text data, timestamps, and optionally associated emotional states.

The term “purchase history” refers to stored records of transactions or acquisitions associated with a user, including at least purchased items, purchase times, and optionally prices or categories.

The term “behavior history” refers to stored data representing user activities or interactions over time, including at least past utterances, actions taken in response to system outputs, or interaction patterns.

The term “event information” refers to data describing one or more events related to a user, including at least dates, types of events such as birthdays or anniversaries, and optionally associated participants.

The term “prompt sentence” refers to a text string or structured textual input that is constructed by a system and provided to a generative AI model as an instruction or context for generating corresponding output text.

The term “generative AI model” refers to a computational model that receives a prompt sentence or other input and generates natural-language output, such as messages or proposals, based on learned patterns in data.

The term “generated text” refers to text output produced by a generative AI model in response to a prompt sentence, including at least one of a message, a proposal, or explanatory content.

The term “message” refers to a unit of generated text intended to be communicated to a user or a related party, which may include information, explanations, or expressions of user awareness, wishes, or regrets.

The term “proposal” refers to a unit of generated text that suggests an action, option, or recommendation to a user or a related party, and that is personalized at least in part based on profile data or an emotional state.

The term “related party” refers to an individual or group associated with a user, other than the user, such as a family member, friend, or other person designated to receive information derived from the user's profile data.

The term “information processing terminal” refers to a computing device having at least one processor, a communication interface, and a user interface, and configured to send data to or receive data from a server and to present information to a user or related party.

The term “communication function” refers to hardware and software components that enable data transmission between devices or systems via a communication network, including at least sending and receiving messages or generated text.

The term “expression style” refers to linguistic characteristics of response content, including formality level, politeness, and phrase choices, that are adjustable by a system based on profile data or an emotional state.

The term “tone” refers to a qualitative attribute of response content, such as being gentle, neutral, or strong, that reflects an attitude or emotional nuance in generated or adjusted text.

The term “amount of information” refers to a quantity or granularity of content included in a response, such as level of detail, length, or number of items, which may be adjusted by a system according to an emotional state or user preference.

The term “response content” refers to information, including text or synthesized speech, that is generated or selected by a system for presentation to a user in reaction to user input or system-internal processing.

The term “display unit” refers to a component of an information processing terminal capable of visually presenting information, such as a screen, monitor, or head-mounted display.

The term “audio output unit” refers to a component of an information processing terminal capable of outputting sound, such as a speaker or earphone, and configured to present spoken or auditory content to a user.

The term “information resource search function” refers to processing that retrieves information from one or more data sources, including local or remote databases or information services, based on query parameters derived from text data or profile data.

The term “schedule management function” refers to processing that creates, modifies, retrieves, or deletes schedule entries, such as appointments or events, and manages timing-related information for a user.

The term “search result information” refers to data returned by an information resource search function, including at least one of documents, records, summaries, or links relevant to a query.

The term “schedule information” refers to data representing one or more scheduled events, including at least times, dates, event descriptions, and optionally participants.

The term “purchase intention” refers to an inferred likelihood that a user is interested in obtaining a good or service, determined based on profile data including at least purchase history, dialogue history, and event information.

The term “gift preference” refers to inferred or explicit information about types of items or experiences that a user prefers to give or receive as a gift, particularly in association with a special day.

The term “special day” refers to a date with particular significance to a user or a related party, including at least a birthday, an anniversary, or a commemorative event.

The term “regret” refers to user-expressed or inferred negative reflection regarding a past event, such as a conflict or dispute with a family member or another related party, as identified through text analysis and profile data.

The term “current issue or worry” refers to a concern, problem, or anxiety presently experienced by a user, which is extracted or inferred from recent user input and profile data.

The term “dialogue history” refers to previously recorded interactions between a user and a system, including at least prior utterances, system responses, timestamps, and optionally derived emotional states or actions taken.

The term “dynamic generation” refers to a process in which a prompt sentence or other output is constructed in real time or near real time based on current data and conditions, rather than being statically predetermined.

The term “indirectly transmits” refers to sending information to a related party in a manner where the information originates from user data and system processing, but is not directly entered by the user as a message to the related party at the time of transmission.

The term “considerate expression” refers to wording selected or generated so as to reduce direct confrontation or offense, by softening or moderating how user awareness, wishes, or regrets are conveyed to a related party.

The term “behavioral change” refers to a modification in actions or patterns of a related party that occurs in response to receiving a generated message or proposal, such as increased communication or supportive behavior.

The term “promotion of communication” refers to an increase in frequency, quality, or depth of interaction between a user and a related party, facilitated by generated messages or proposals.

In one embodiment, a system includes a server, one or more terminals, at least one storage device, and at least one communication network. The server and the terminals each include at least one processor and at least one memory storing instructions which, when executed by the processor, implement the functions described below.

The server uses general-purpose computing hardware, such as a multi-core central processing unit and optional graphics processing units, running an operating system, such as a common server operating system. The server is connected to at least one storage device, such as a relational database system or a document-oriented database system, to store profile data, dialogue history, purchase history, and model parameters. The server communicates with terminals via a communication network such as the Internet, using a protocol such as HTTPS with transport-layer security.

The terminal uses client hardware such as a smartphone, a tablet, a smart speaker, a wearable device, or a personal computer. The terminal includes at least a microphone, a speaker, a display, a communication interface, and a local processor. The terminal executes client-side software implemented as a native application or a web application that interacts with the server.

The terminal acquires audio data by capturing the user's speech through the microphone. The terminal samples the acoustic signal using an audio framework of the client platform, for example a mobile audio framework, at a specified sampling rate and bit depth, and converts the continuous analog signal into digital audio data. The terminal can apply pre-processing, such as noise suppression and echo cancellation, to improve the quality of the digital audio data. The terminal then stores the digital audio data in a temporary buffer in the memory.

The terminal converts the digital audio data into text data by using a speech recognition technique. The terminal sends the digital audio data to a speech recognition engine hosted on the server or on a remote recognition service. The speech recognition engine may implement a hybrid architecture including an acoustic model, a pronunciation model, and a language model, or may implement an end-to-end neural recognition architecture, such as a recurrent neural network or a transformer-based model trained on paired audio-text data. The engine outputs one or more candidate transcripts and associated confidence scores. The terminal or the server selects a transcript with the highest combined confidence score, and the server normalizes the transcript by performing operations such as lowercasing, punctuation normalization, and removal of non-speech artifacts. The resulting normalized text data serves as the input to subsequent natural language processing.

The server applies a natural language processing technique to the text data to obtain extracted information regarding the user's requests, intentions, interests, wishes, worries, and regrets.

The server uses a text-processing pipeline built on a natural language processing library. The server performs tokenization, sentence segmentation, part-of-speech tagging, and dependency parsing on the text data. The server uses a named-entity recognition model to detect entities such as persons, dates, times, locations, and product categories. The server feeds the tokenized and annotated text into an intent classification model, which may be implemented as a fine-tuned transformer network. The intent classification model receives, for each utterance, an embedding sequence, applies multiple attention layers, and outputs a probability distribution over a predefined set of intent classes, such as “information request,” “recommendation request,” “emotional disclosure,” “event notification,” or “schedule request.” The server selects the intent with the maximum probability as the recognized intent.

The server performs phrase extraction by identifying noun phrases, verb phrases, and multi-word expressions that satisfy predetermined syntactic patterns and salience scores. The server can compute salience scores using measures such as term frequency-inverse document frequency or attention weights obtained from the intent classification model. In this way, the server identifies phrases such as “new running shoes,” “mother's birthday,” “new smartphone,” or “too busy at work.”

The server applies an emotion analysis technique to the text data to classify an emotional state of the user. The server uses a neural emotion classifier that takes as input an embedding of the text data, for example a word-piece embedding, and passes it through multiple transformer or recurrent layers. The model outputs emotion scores for multiple emotion categories, such as joy, anger, sadness, fear, surprise, and neutral. The server computes an emotion score vector and selects the category with the highest score as the primary emotional state. The server may also maintain calibrated thresholds to identify mixed states when multiple scores exceed thresholds. The server stores both the categorical label and the continuous emotion score vector.

The server stores this extracted information and emotional state as profile data. The server maintains a user profile record in a database with fields such as user identification information, a list of recent utterances and their intents, a list of extracted phrases, a list of recognized emotional states and corresponding timestamps, purchase history entries, and event information. The server aggregates the extracted information and integrates it with past dialogue history and purchase history by updating arrays or relational tables associated with the user identification information. For example, the server maintains a profile field “interests” as a ranked list of topics, where ranks are updated using an exponential decay function over time so that recent utterances have greater influence. The server may maintain an “emotion trend” field that stores a time series of emotion labels and scores to detect long-term patterns.

The server analyzes purchase history by loading transaction records from the database into an in-memory analysis module that can be implemented using a data analysis library. The server groups purchases by item category, time of year, and recipient tags and detects recurring patterns such as gift purchases near specific calendar dates. The server then writes inferred event information, such as a probable birthday date for a related party, to the user's profile data. This tight integration of historical records and text-derived events allows the server to generate more accurate prompts and to reduce redundant external queries.

The server generates a prompt sentence for a generative AI model based on the profile data and the current dialogue context. The server assembles a textual instruction that encodes, in one coherent sequence, the user's recognized intent, the key phrases extracted from the current utterance, summaries of relevant sections of the profile data, and the current emotional state. The server uses template structures and rule-based transformations rather than simply concatenating free text. For example, the server may construct a prompt sentence:

“The user said: ‘I recently started running and I want new running shoes.’ The extracted keywords are: running, running shoes. The user is a beginner and the emotion is joy and excitement. Based on this, please propose three to five types of running shoes suitable for a beginner. For each type, describe cushioning, stability, typical price range, and what kind of runner it suits. Return your answer in concise English bullet points.” In another example, the server may construct a prompt sentence:

“User A feels regret because work has been very busy and they cannot spend enough time with their family. The emotion is sadness and regret. Please create a gentle, empathetic message addressed to User A's family that explains these feelings and encourages planning a pleasant time together. Keep the tone warm and supportive.” In yet another example, the server may construct a prompt sentence:

“The user mentioned that next week is their mother's birthday. Generate a friendly reminder message that can be sent to the user's siblings to encourage them to prepare a celebration.”

The server passes the constructed prompt sentence as input to the generative AI model. The generative AI model is implemented as a large-scale neural language model, such as a transformer-based network with multiple self-attention layers, feed-forward layers, layer normalization, and residual connections. The model parameters are learned from large corpora of text data using a language modeling objective. In one embodiment, the model is pre-trained on a general corpus and fine-tuned on task-specific data such as family messages and supportive recommendations. The training is carried out by computing a loss function, for example a cross-entropy loss between predicted token probabilities and ground-truth tokens, and updating model weights using an optimization method such as stochastic gradient descent, adaptive moment estimation, or a related algorithm. The server, or an associated training system, can apply data augmentation techniques, such as paraphrasing and back-translation of training sentences, to increase robustness.

The server uses the generative AI model in an inference mode. The server feeds the prompt sentence tokens into the model, obtains a sequence of token probability distributions at the output layer, and performs decoding using greedy decoding, beam search, or nucleus sampling to generate the output text until an end-of-sequence token is produced or a maximum length is reached. The server can apply constraints, such as limiting the set of allowable tokens in certain positions, to enforce polite expressions or to prevent disallowed content. The server then concatenates the generated tokens into a generated text string that constitutes a message or a proposal.

The server extracts from the generated text the content that is to be delivered to a related party or to the user. When the generated text is in a known structural format (for example, a first paragraph addressed to the user and a second paragraph addressed to the family), the server applies simple rule-based parsing. In other cases, the server may use markers included in the prompt (for example, explicit labels such as “Message to family:”) to identify the target portions. The server then associates each portion with a target, such as the user's terminal or a related party's terminal.

The server indirectly transmits a message or a proposal to the related party via the communication function. The server uses a messaging infrastructure such as a push notification service, an email protocol, or a messaging platform interface. The server builds a data payload that includes at least a recipient identifier (for example, an account ID or a device token), the generated message text, and metadata such as the originating user ID and the event identifier. The server sends this payload through a communication interface of the server to a messaging gateway, which then delivers the message to the information processing terminal of the related party. Because the message text is generated based on the user's profile and emotional state and because the user does not directly input the exact final message, the delivery is indirect.

The server also adjusts the response content to be presented to the user based on the generated text and the recognized emotional state. For example, when the user's emotion is joy, the server may generate or select a response with an upbeat tone and shorter explanations; when the emotion is sadness or anger, the server may increase the politeness level, include supportive expressions, and reduce the number of questions. The server implements this adjustment either by instructing the generative AI model in the prompt sentence to adopt a specific style or by post-processing the generated text. Style control can be implemented by including style tokens or control phrases in the prompt, while post-processing may include insertion or replacement of certain phrases based on rule sets.

The terminal presents the adjusted response content to the user. The terminal displays text messages on a display or plays synthesized speech via the speaker by using a text-to-speech engine. The terminal may apply local interface logic, such as splitting a long text into multiple cards or pages, to improve readability.

The server executes an information resource search function and a schedule management function in cooperation with the profile data and the text data. The server serves as a client to an external search service, formatting a query string that uses extracted phrases and entity types from the user's utterance. The server sends the query to the external service and receives a list of search results. The server may filter and reorder the results based on the user's profile, for example prioritizing family-oriented events when the user often talks about family. The server also acts as a client to a calendar service by constructing an event object containing a title, a date, a time, and an optional description, derived from event information extracted from the text data and the profile data. The server sends the event object to the calendar service, which stores the event in the user's schedule. The terminal can then display these search results and scheduled events.

This system yields technical effects that go beyond simply automating human communication. By constructing and maintaining structured profile data that tightly integrates semantic information and emotional states, the server can avoid repeatedly re-analyzing large volumes of past dialogue data, thereby reducing computational load and improving response latency. By generating prompt sentences that explicitly encode only the relevant subset of profile data and current context, the server reduces the input size to the generative AI model and thus reduces computational burden within the model, which contributes to faster generation and lower network load. The precise encoding of context also improves the accuracy and stability of the model's outputs because the model receives information that has been pre-structured for the task rather than raw natural language history.

The server improves data management by using explicit data structures for profile data, such as normalized tables or structured documents, instead of ad hoc text logs. This allows the server to perform indexed queries and join operations when constructing prompts or analyzing user trends, thereby enhancing throughput and scalability. The emotion analysis module uses numerical emotion scores and time-series aggregation techniques to detect trends and anomalies, which can be exploited to adjust the intensity of notifications or to reduce the frequency of unnecessary prompts, thus reducing communication load and avoiding user fatigue.

The generative AI model is integrated into the system as a specialized text generator that operates under constraints derived from the profile data and system rules. The use of transformer-based architectures with attention mechanisms allows the model to focus on the key parts of the prompt sentence. The training process incorporates loss functions not only for next-token prediction but also, in some embodiments, for style alignment or politeness enforcement, by including auxiliary classification heads that predict style labels and by adding corresponding terms to the loss. The server can fine-tune the model on domain-specific data such as family-oriented messages or customer support dialogues, which improves the quality and appropriateness of generated messages in this application.

The system differs from simple human task automation in that it applies non-conventional pre-processing and prompt construction rules that are specifically designed to optimize the behavior of the generative AI model and to manage multi-recipient conversational flows. For example, the server can enforce a rule that any message directed to a related party must not reveal certain sensitive profile fields and must phrase user regrets in a non-accusatory form.

These rules are encoded as deterministic transformations on the extracted information, and they are applied before the generative AI model receives the prompt sentence. This hybrid of rule-based control and learned generation results in a controlled, safe, and contextually rich output, which a human operator would not be able to consistently produce across many users and messages at the same speed and scale.

The server can be implemented in various configurations. In one configuration, all natural language processing, emotion analysis, profile management, prompt generation, and generative AI inference are executed on a single physical server. In another configuration, these functions are distributed across multiple microservices, such as a speech recognition service, an NLP service, an emotion service, a profile service, a prompt construction service, and a text generation service, each running on separate compute nodes and communicating via an internal network. In a further configuration, inference for the generative AI model is offloaded to a specialized accelerator cluster optimized for matrix operations, while the remaining logic runs on general-purpose processors.

The system also supports alternative learning and deployment strategies. In one variant, the emotion analysis model and the intent classification model are periodically retrained based on newly collected anonymized data to adapt to changing language usage. The training procedure uses mini-batch stochastic optimization, gradient clipping to avoid exploding gradients, and regularization techniques such as dropout and weight decay to prevent overfitting. In another variant, the generative AI model uses quantization of weights to lower precision and thereby improve inference speed and reduce memory usage on the server hardware, without significantly harming output quality.

The system can be applied in multiple use cases, such as family communication support, recommendation of goods and services, and real-time assistance in physical environments. In each case, the same technical architecture speech-to-text conversion, natural language understanding, emotion analysis, profile-based prompt sentence generation, controlled generative text output, and targeted delivery to terminals provides improved processing efficiency, higher accuracy in personalization, and reduced network and computational overhead compared to naive implementations that pass full dialogue histories or unstructured logs to a generative model.

By implementing the system as described, the server and the terminals cooperate to achieve a computer-implemented technology that materially improves the functioning of the conversational system itself, including its data structures, model integration, and processing flow, rather than merely executing a mental or business process on generic hardware.

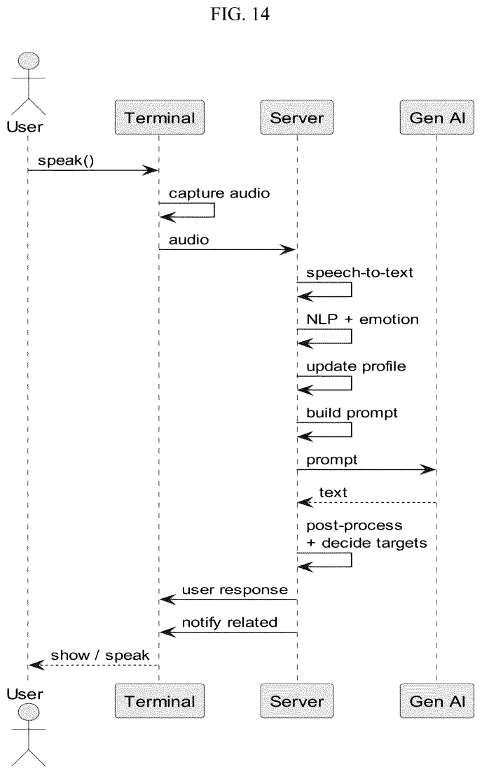

The following describes the processing flow using FIG. 14.

### Step 1

User provides spoken input.

User speaks to the terminal in natural language, for example, “I recently started running and I want new running shoes,” or “Next week is my mother's birthday.”

Input: Human speech (analog acoustic signal).

Output: Acoustic sound waves at the microphone.

User produces the sound, and no digital processing is performed by the user.

### Step 2

Terminal captures and digitizes audio.

Terminal activates a microphone, samples the acoustic signal at a defined sampling rate and bit depth, and converts the analog signal to digital audio frames. Terminal stores these frames in a memory buffer and optionally applies noise suppression and echo cancellation.

Input: Acoustic sound waves from the user.

Output: Digital audio data (for example, PCM frames or an audio file).

Terminal performs analog-to-digital conversion, windowing, and buffering to transform the continuous sound into discrete numerical samples.

### Step 3

Terminal generates an audio payload and sends it for speech recognition.

Terminal packages the digital audio data into a suitable container format (for example, WAV or compressed stream), adds metadata such as sampling rate and language code, and sends the payload via a communication interface to a speech recognition engine implemented on the server or on a remote recognition service.

Input: Digital audio data from the microphone buffer.

Output: A network request containing an audio payload and configuration parameters.

Terminal performs data encapsulation, formats headers, and initiates an encrypted HTTPS connection to transmit the audio.

### Step 4

Server converts audio to text using a speech recognition technique.

Server receives the audio payload, decodes the container format, and inputs the digital audio stream into a speech recognition model. The model computes acoustic features (for example, mel-frequency cepstral coefficients), applies a neural network acoustic model (for example, recurrent or transformer layers), and combines outputs with a language model to produce candidate transcripts with confidence scores.

Input: Digital audio data and recognition configuration.

Output: Recognized text data (one or more candidate transcripts and confidence values).

Server executes feature extraction, probability computation over phonetic or subword units, decoding via beam search, and selection of the best-scoring transcript as normalized text.

### Step 5

Server normalizes the recognized text.

Server processes the raw transcript to standardize formatting. Server lowercases text where appropriate, normalizes punctuation, removes non-linguistic markers (for example, “uh,” “um”), and corrects obvious recognition artifacts using rule-based filters.

Input: Recognized text data and confidence scores.

Output: Normalized text data suitable for natural language processing.

Server applies string manipulation, token-level rules, and possibly a lightweight language model to clean and standardize the text.

### Step 6

Server performs natural language preprocessing.

Server applies a natural language processing pipeline to the normalized text. Server tokenizes the text into words or subword units, splits the text into sentences, and assigns part-of-speech tags to each token. Server then runs a dependency parser to determine syntactic relations between tokens.

Input: Normalized text data.

Output: Annotated text structure (tokens, sentences, part-of-speech tags, dependency edges).

Server performs lexical analysis, grammatical tagging, and syntactic tree construction, generating an internal representation for subsequent semantic analysis.

### Step 7

Server extracts key phrases and entities.

Server uses pattern-based rules and statistical scores to identify noun phrases, verb phrases, and relevant multi-word expressions, such as “new running shoes” or “mother's birthday.”

Server runs a named-entity recognizer to detect entity types such as persons, dates, locations, and product categories.

Input: Annotated text structure.

Output: A set of extracted phrases and recognized entities with associated types and positions.

Server computes salience scores (for example, term frequency-inverse document frequency or attention weights) and applies syntactic constraints to select informative phrases and entities.

### Step 8

Server classifies user intent.

Server encodes the text as an embedding sequence and inputs it into an intent classification model, such as a fine-tuned transformer network. The model computes contextual embeddings through multiple attention layers and outputs probabilities over intent classes (for example, “product recommendation request,” “event registration,” “emotional disclosure”)

Input: Annotated text structure or raw normalized text.

Output: An intent label and a probability distribution over possible intents.

Server performs vectorization, forward propagation through neural layers, softmax computation, and argmax selection to determine the most likely intent.

### Step 9

Server performs emotion analysis.

Server passes the text representation into an emotion classification model. The model calculates emotion scores for categories such as joy, anger, sadness, fear, and neutral. Server normalizes these scores and selects the dominant emotion; optionally, server stores the full score vector to preserve intensity information.

Input: Normalized text data and possibly extracted features (for example, sentiment lexicon hits).

Output: An emotional state label and a corresponding emotion score vector.

Server performs feature extraction, neural network inference, and probability normalization to classify the user's emotional state.

### Step 10

Server updates user profile data.

Server retrieves the existing profile record for the user from a database. Server integrates the current extracted phrases, entities, intent, and emotional state into the profile. For example, server adds “running” to the interest list or updates an “emotion trend” time series with a new entry. Server may also update inferred event fields based on recognized dates (for example, adding or refining “mother's birthday” information).

Input: Extracted phrases and entities, intent label, emotional state, and current profile record.

Output: An updated profile record stored in the database.

Server performs database read, merges new data into existing lists or time series using ranking or decay functions, and writes the updated structure back to storage.

### Step 11

Server analyzes purchase and behavior history (if available).

Server loads purchase history and relevant behavior logs for the user. Server groups items by category, date, and recipient, and computes statistics such as frequency of gift purchases near certain dates. Server identifies recurring patterns that may correspond to special days or preferences.

Input: Purchase history records and behavior logs associated with the user.

Output: Inferred event information and refined preference indicators stored in the profile.

Server executes aggregation, filtering, and clustering operations, such as grouping by date ranges or categories, and updates profile fields to reflect inferred events and preferences.

### Step 12

Server decides the next system action.

Server evaluates the intent, emotional state, and profile data to determine what action to perform. For example, server may decide to generate a product recommendation, to create a message for family members, to provide emotional support, or to schedule an event.

Input: Intent label, emotional state, and updated profile record.

Output: An internal action descriptor specifying the type of action and its targets (user and/or related parties).

Server applies rule-based logic or a learned policy that maps combinations of intent and emotion to action types.

### Step 13

Server constructs a prompt sentence for the generative AI model.

Server assembles a textual prompt that encodes the current utterance, key phrases, relevant profile summaries, and emotional state in a structured format. Server selects only the most pertinent profile fields to limit prompt size and improve efficiency.

Input: Action descriptor, extracted phrases and entities, intent, emotional state, and selected profile fields.

Output: A prompt sentence text string tailored to the chosen action.

Server performs template filling and rule-based sentence construction to combine structured fields into a coherent instruction, such as:

“The user said: ‘I recently started running and I want new running shoes.’ The extracted keywords are: running, running shoes. The user is a beginner and the emotion is joy and excitement. Based on this, please propose three to five types of running shoes suitable for a beginner. For each type, describe cushioning, stability, typical price range, and what kind of runner it suits. Return your answer in concise English bullet points.”

### Step 14

Server sends the prompt sentence to the generative AI model and generates text.

Server tokenizes the prompt sentence and sends it to the generative AI model endpoint. The model computes contextual embeddings through its transformer layers, calculates token probabilities at each position, and decodes a sequence of output tokens using a decoding strategy such as beam search or nucleus sampling.

Input: Prompt sentence text.

Output: Generated text containing a message and/or a proposal.

Server performs API invocation, feeds the prompt into the model, receives token probability distributions, and reconstructs the generated output text from the decoded tokens.

### Step 15

Server post-processes the generated text and assigns targets.

Server parses the generated text to identify which parts are intended for the user and which parts are intended for related parties. Server may rely on markers or sections requested in the prompt (for example, “Message to family:”). Server extracts the specific message body and any recommendation bullet points.

Input: Generated text from the generative AI model.

Output: Structured message objects with designated recipients and content strings.

Server executes text segmentation, pattern matching, and simple parsing rules to separate and label portions of the generated output.

### Step 16

Server adjusts response content for the user.

Server modifies or selects user-facing response content based on the emotional state and the generated text. For example, when the emotion is sadness, server may prepend empathetic phrases or soften direct suggestions; when the emotion is joy, server may adopt more enthusiastic language.

Input: Generated user-directed content and emotional state.

Output: Adjusted response text to present to the user.

Server applies style rules and phrase substitution, or invokes the generative AI model with a short refinement prompt, to align tone and information density with the emotional state.

### Step 17

Server prepares messages for related parties.

Server packages the generated indirect message or proposal for related parties into delivery-ready objects, including recipient identifiers, message text, and metadata (for example, originating user ID and event type).

Input: Generated related-party message content and recipient mapping.

Output: Message payloads formatted for external messaging services.

Server performs data structuring and encoding for use with messaging protocols or push notification services.

### Step 18

Server executes information search and schedule management (if required).

Server constructs a search query based on extracted phrases and entities and sends the query to an external search service. Server receives and optionally ranks search results. Server also creates schedule entries using dates and event descriptions, then sends them to a calendar service.

Input: Extracted phrases and entities, intent label, and profile context.

Output: Search results and/or created schedule entries.

Server performs query building, API requests, result filtering, event object construction, and calendar API calls.

### Step 19

Server sends responses and notifications to terminals.

Server transmits the adjusted user response, search results, and schedule information to the user's terminal. Server also transmits the indirect messages or proposals to the terminals of related parties via messaging services or push notification gateways.

Input: Adjusted user response, search results, schedule entries, and related-party message payloads.

Output: Network messages delivered to corresponding terminals.

Server formats outgoing JSON or protocol messages, selects appropriate endpoints, and initiates secure connections for transmission.

### Step 20

Terminal presents information to the user and related parties.

Terminal receives the server's responses, parses the payloads, and renders content on its user interface. For the user, terminal displays response text, product recommendations, and schedule confirmations, and may play speech via text-to-speech. For related parties, terminal displays received indirect messages as notifications, chat messages, or emails.

Input: Received server responses and message payloads.

Output: Visual and/or auditory presentations on displays and speakers.

Terminal executes UI rendering, message listing, notification display, and optional audio synthesis to present the content to humans.

### Step 21

User optionally performs follow-up actions.

User may select recommended products, confirm or modify schedule entries, or respond to messages. User actions generate new input events, such as button presses or new spoken commands, which the terminal captures and forwards to the server for further processing.

Input: Displayed information and user decisions.

Output: New interaction events (for example, purchase requests, schedule changes, or replies).

User interacts with the terminal UI, and terminal encodes these interactions as structured events for the server, leading to subsequent iterations of the processing flow.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

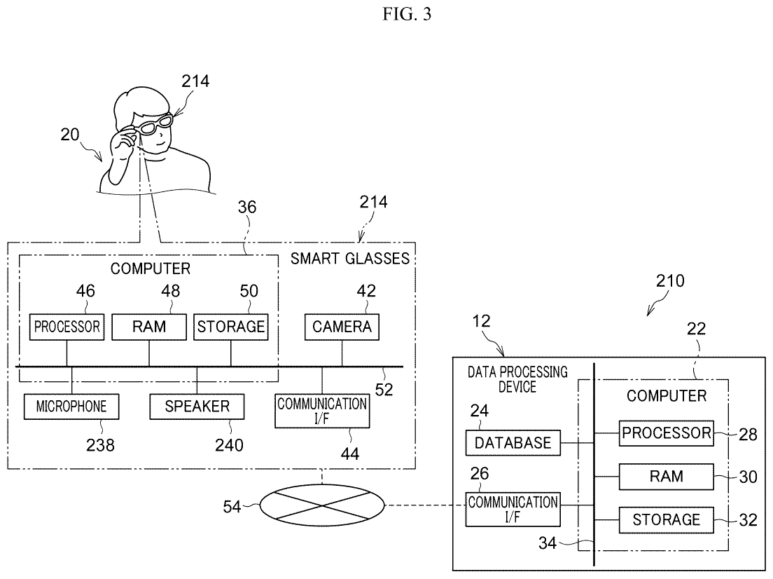

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

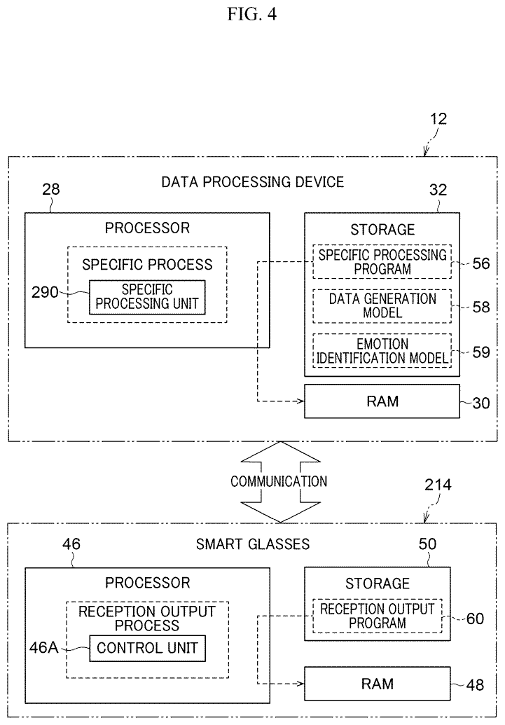

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

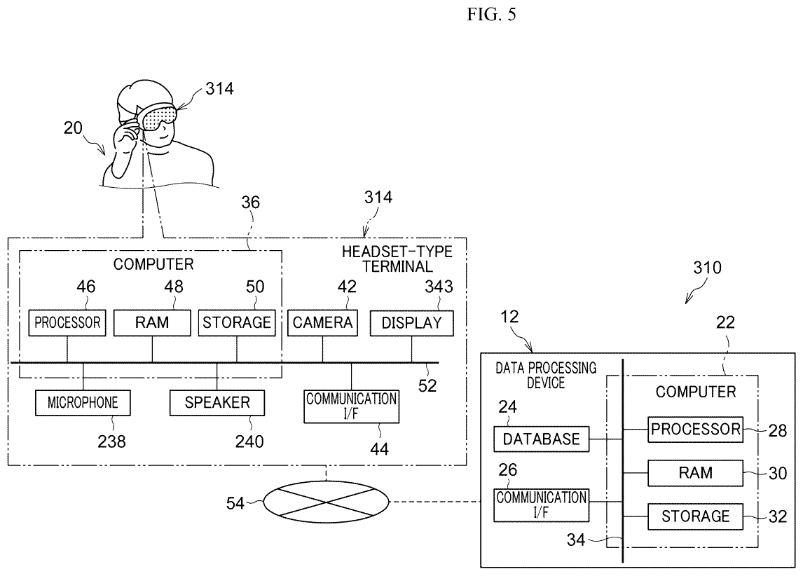

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

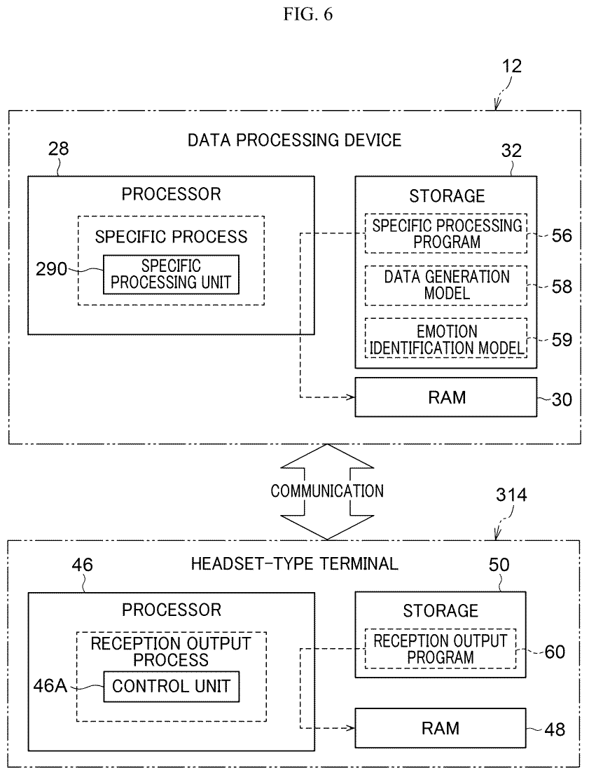

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

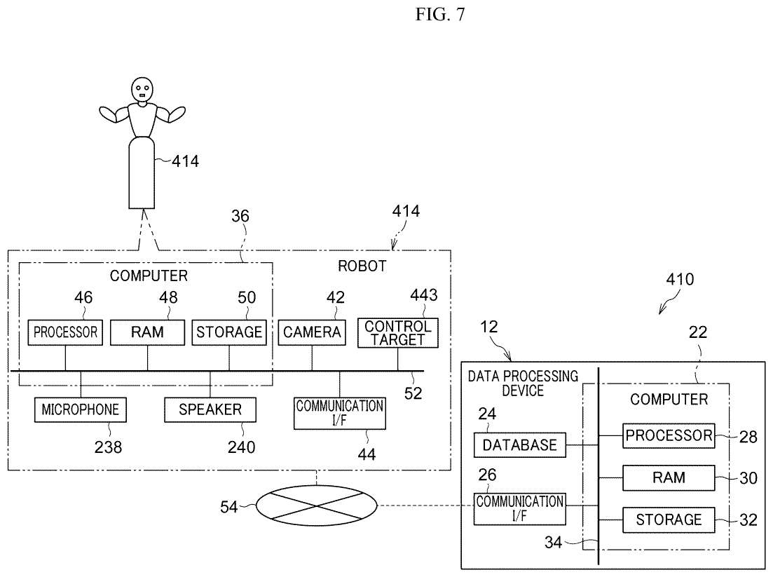

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

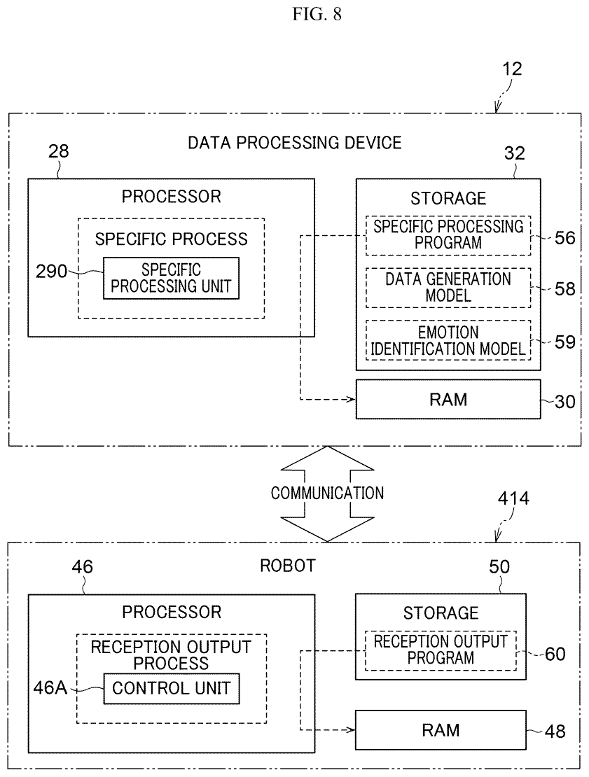

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

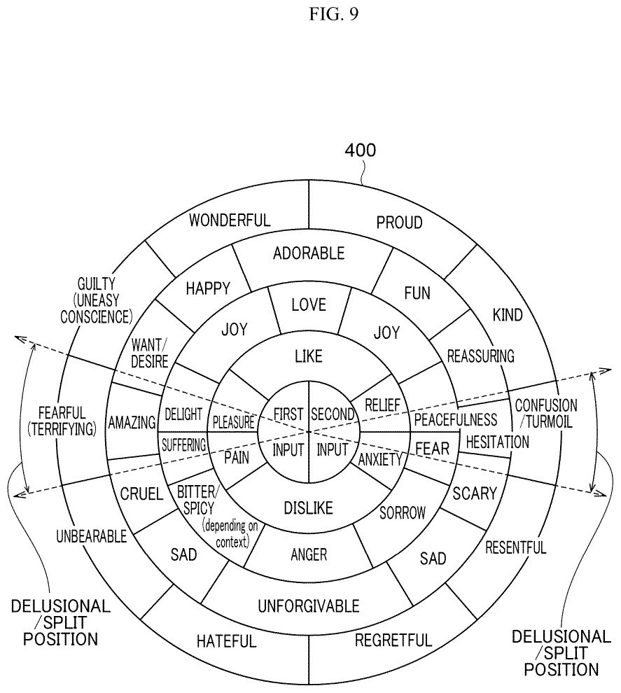

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

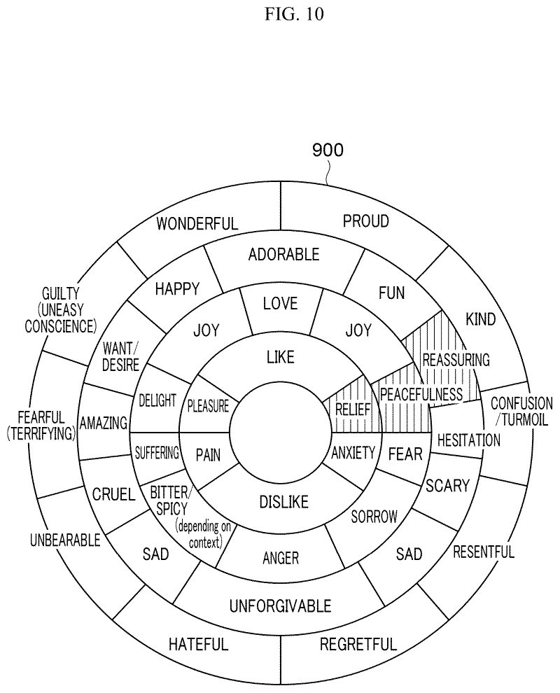

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire dialog data from a user as an audio signal or a character string, and generate text data by performing either a speech recognition process on the audio signal or a character-string acquisition process on the character string, and
analyze the text data by performing natural language processing to interpret a request and an intention of the user, identify whether the request is an information-acquisition request or a schedule-management request, classify and recognize an emotional state of the user from the text data, and associate the request, the intention, and the emotional state as attribute information of the user to store as profile data, and
determine, based on an analysis result, a type of access to an external information source, acquire environment information from an information-providing service in response to the information-acquisition request, acquire schedule information from a schedule-management service or a schedule database in response to the schedule-management request, and integrate and manage the acquired environment information or the acquired schedule information in an internal data structure, and
generate, based on the integrated environment information or schedule information and the profile data, a prompt sentence for a generative AI model, the prompt sentence instructing the generative AI model to generate, according to a type of the request and the emotional state of the user, a natural-language response that explains an information-retrieval result or schedule information in an easy-to-understand manner and to generate a personalized proposal or a message to a related party other than the user according to the emotional state and an interest of the user, and
input the generated prompt sentence into the generative AI model, and generate, by numerical computation processing of the generative AI model including the integrated environment information or schedule information, a natural-language response for the user and a natural-language message or a proposal for the related party other than the user, and
indirectly transmit the generated natural-language message or proposal for the related party other than the user to an information-processing terminal used by the related party, and
adjust, based on the recognized emotional state of the user, expression content and a presentation mode of the generated natural-language response for the user, present the generated natural-language response in real time via a display unit or an audio output unit of an information-processing terminal used by the user, and provide an information-retrieval function for the information-acquisition request and a schedule-management function for the schedule-management request.

### Supplementary 2

The system according to supplementary 1,
wherein the processor is configured to
analyze the profile data to identify a purchase intention of the user, a preference for a gift on a special day such as an anniversary, a regret caused by a past interpersonal conflict, and a current issue or concern of the user, and, based on the identification result and the integrated environment information or schedule information, create a prompt sentence that instructs the generative AI model to generate a personalized proposal or message for the user or for the related party other than the user, and input the prompt sentence into the generative AI model to cause the generative AI model to generate the proposal or the message.

### Supplementary 3

The system according to supplementary 1,
wherein the processor is configured to
cause the prompt sentence input into the generative AI model to include content that, based on the emotional state of the user and the profile data, instructs output of a natural-language message that conveys an awareness or an inner intention of the user to the related party other than the user in a considerate and mild expression, or instructs output of a proposal that supports the user according to an interest and schedule information of the user together with an explanation of an information-retrieval result or schedule information, and cause the generated message or proposal to be provided to the related party with an expression that gently shows empathy according to the prompt sentence.

### Application Example 1

### Supplementary 1

A system comprising a processor,
wherein the processor is configured to
collect voice interaction from a user through a terminal and convert collected audio data into text data by using a speech recognition technique,
analyze the text data and item identification information transmitted from the terminal by using a natural language processing technique so as to determine a request and an intention of the user and to retrieve item information including inventory information and related-item information from a data storage device,
associate the determined request and intention of the user with the retrieved item information, update user profile data and purchase history data, and generate a prompt sentence for a generative AI model based on the user profile data and the purchase history data so as to cause the generative AI model to generate a response regarding an inventory status and a personalized proposal of related items,
input the generated prompt sentence into the generative AI model and obtain, from the generative AI model, a response text including the inventory status and the proposal of the related items,
transmit the obtained response text to the terminal and cause a visual display device of the terminal to display the response text in real time,
provide an information search function and a schedule management function to the user based on the user profile data and the obtained response text, and store a use history of the functions as part of the purchase history data, and
update contents of future prompt sentences and proposal contents generated by the generative AI model based on the purchase history data and the use history of the information search function.

### Supplementary 2

The system according to supplementary 1,
wherein the processor is configured to
cause the generative AI model, based on the user profile data, the purchase history data, and the item information, to extract candidates of related items reflecting a preference, a price tendency, and a co-purchase pattern of the user, rank the candidates according to a priority, and incorporate the ranked candidates into the prompt sentence so that the response text generated by the generative AI model includes a personalized proposal of the related items for the user.

### Supplementary 3

The system according to supplementary 1,
wherein the processor is configured to
control the terminal so that the terminal has an augmented-reality display function that superimposes the inventory information and the proposal of the related items included in the response text in a field of view in association with an item currently viewed by the user, and receive, as part of the purchase history data, selection operations or additional inputs of the user with respect to information displayed by the augmented-reality display function.

### Example 2

### Supplementary 1

A system comprising a processor,
wherein the processor is configured to
acquire a voice interaction with a user via an acoustic input-output function of a terminal, and convert acquired voice information into character information by using a speech recognition technique,
analyze the character information by using a natural language processing technique to extract information on a request, an intention, an interest, a wish, a concern, or a regret of the user, and classify a basic emotion shown by the user into an emotional state,
associate the extracted information on the request, the intention, the interest, the wish, the concern, or the regret of the user with the recognized emotional state as profile information of the user, store the profile information in an information storage device, and update and manage the profile information over time,
generate a first prompt sentence based on the profile information of the user and the character information, the first prompt sentence instructing a generative AI model having a generative processing function to generate content that gently conveys an awareness of the user to a related party associated with the user, or to generate a personalized proposal according to the emotional state or the interest of the user, and input the first prompt sentence to the generative AI model so as to cause the generative AI model to generate a message or a proposal to the related party,
transmit the generated message or proposal indirectly, via a communication network, to an information terminal used by the related party other than the user,
adjust a response content to the user based on the recognized emotional state and the profile information of the user, and present the response content sequentially and in real time via a display output or a voice output of a user terminal,
provide an information retrieval function and an action planning management function in response to a request from the user, and
generate, using the voice interaction of the user, the character information, the profile information of the user, and a past response history as input information, an analysis prompt sentence and a proposal-generation prompt sentence in stages, and perform input control to the generative AI model and structuring processing of an output result from the generative AI model, thereby automatically executing estimation of a need of the user and generation of personalized service content.

### Supplementary 2

The system according to supplementary 1,
wherein the processor is configured to analyze the profile information of the user and the
emotional state, identify a purchasing willingness of the user, a desire for a gift on a special day, a regret relating to a past interpersonal conflict, and a current task or concern, generate an analysis prompt sentence and a proposal-generation prompt sentence corresponding to the identified items, input the analysis prompt sentence and the proposal-generation prompt sentence to the generative AI model, and thereby control the generative AI model to generate a personalized message or proposal to the user or the related party of the user.

### Supplementary 3

The system according to supplementary 1,
wherein the processor is configured to cause the prompt sentence input to the generative AI model to include an analysis instruction for estimating a need of the user and a generation instruction for generating a plurality of candidate proposal examples according to the emotional state and the interest of the user, and to adjust the message or proposal generated by the generative AI model such that the message or proposal is provided as an expression that gently and empathetically conveys the awareness of the user to the related party.

### Application Example 2

### Supplementary 1

A system comprising a processor,
wherein the processor is configured to
acquire audio data representing spoken input from a user and record the audio data as digital audio data,
convert the digital audio data into text data by using a speech recognition technique, apply a natural language processing technique to the text data to perform sentence structure analysis, phrase extraction, and intent classification, and thereby generate extracted information regarding a request and an intention of the user and regarding interests, wishes, worries, or regrets held by the user,
apply an emotion analysis technique to the text data to calculate emotion scores for a plurality of emotions including joy, anger, sadness, and surprise, and classify and recognize an emotional state of the user based on the emotion scores,
store the extracted information and the emotional state as profile data associated with user identification information in a database of a storage apparatus and update the profile data by integrating the extracted information and the emotional state with past dialogue history and purchase history,
generate a prompt sentence for input to a generative AI model based on the profile data and current dialogue content, the prompt sentence including summary information regarding the request, the intention, the interests, the wishes, the worries, or the regrets of the user and summary information regarding the emotional state of the user,
transmit the generated prompt sentence to the generative AI model and obtain generated text from the generative AI model, the generated text including a message that indirectly communicates an awareness of the user to a related party other than the user or including a personalized proposal corresponding to the emotional state or the interests of the user, extract content of the message or the proposal from the generated text and indirectly transmit the message or the proposal, via a communication function, to an information processing terminal of the related party other than the user,
adjust an expression style, a tone, or an amount of information of response content to be presented to the user based on the generated text and the emotional state of the user, and
present the adjusted response content to the user in real time via a display unit or an audio output unit of an information processing terminal of the user, and
execute an information resource search function and a schedule management function based on the text data and the profile data and present search result information and schedule information to the information processing terminal of the user.

### Supplementary 2

The system according to supplementary 1,
wherein the processor is configured to
analyze the profile data to estimate, from a purchase history of the user, a behavior history of the user, and recorded event information, at least one of a purchase intention of the user, a gift preference of the user for a special day including a birthday or an anniversary, a regret of the user regarding a past conflict or dispute with a family member or another related party, and a current issue or worry of the user, and to dynamically generate, based on an estimation result and the emotional state of the user, a prompt sentence that instructs the generative AI model to generate a personalized proposal or message, and to input the prompt sentence to the generative AI model so that the generative AI model generates the proposal or the message.

### Supplementary 3

The system according to supplementary 1,
wherein the processor is configured to
construct the prompt sentence to be input to the generative AI model in accordance with the emotional state of the user, the dialogue history, and the profile data, and to control the generative AI model such that the generated message or proposal conveys an awareness, a wish, or a regret of the user to the related party in a considerate expression that avoids direct confrontation and induces a behavioral change or promotion of communication by the related party.

What is claimed is:

1. A system comprising:
circuitry configured to:
receive, via a communication interface coupled to a packet-switched network, dialog data from a terminal device as an audio signal or a character string, and generate text data by performing a speech recognition process on the audio signal or a character-string acquisition process on the character string;
analyze the text data by performing natural language processing to interpret a request and an intention of the user, classify and recognize an emotional state of the user from the text data, and associate the request, the intention, and the emotional state as attribute information of the user for storage as profile data in a storage device;
determine, based on an analysis result, a type of access to an external information source, acquire environment information or schedule information from at least one of an information-providing service and a schedule management service via the communication interface, and integrate and manage the acquired information in the storage device;
create, based on the profile data, a prompt sentence for instructing a generative AI model to generate a message or a proposal for a target user, and input the prompt sentence to the generative AI model to obtain generated content; and
transmit the generated content to a terminal device associated with the target user via the communication interface, and adjust a response presented to the user on the basis of the recognized emotional state.

2. The system according to claim 1, wherein the circuitry is configured to analyze the profile data to identify an intention category, a preference for a predefined event type, a regret pattern derived from past dialog data, and a current concern of the user, and create a prompt sentence for instructing the generative AI model to generate a personalized proposal based on the identified profile attributes.

3. The system according to claim 2, wherein the circuitry is configured to apply a temporal analysis model to the profile data to identify recurring patterns in the user's emotional states and intention categories across accumulated dialog sessions, and incorporate the identified patterns as conditioning parameters in the prompt sentence.

4. The system according to claim 3, wherein the circuitry is configured to generate a message configured to convey the user's awareness to the target user in an expression adapted to the target user's relationship type, and transmit the message to the terminal device of the target user at a dynamically determined delivery time.

5. The system according to claim 4, wherein the circuitry is configured to apply a relationship type classifier to profile data of the user and the target user to identify a relationship category, and adjust the message generation parameters in the prompt sentence based on the relationship category.

6. The system according to claim 1, wherein the circuitry is configured to apply a speech recognition model to the audio signal to generate a transcription, apply a prosody analysis model to the audio signal to extract pitch contours, speaking rate, and energy features, and combine the prosodic features with the transcription for input to the emotional state classification model.

7. The system according to claim 6, wherein the circuitry is configured to classify the emotional state into a plurality of predefined emotion categories, generate a confidence score for each category, and store the classified emotional state together with a timestamp in the profile data.

8. The system according to claim 1, wherein the circuitry is configured to apply a named entity recognition model to the text data to extract person entities, date entities, and location entities, and associate the extracted entities with the request and intention attributes in the profile data.

9. The system according to claim 8, wherein the circuitry is configured to apply a coreference resolution model to a sequence of text data items accumulated over multiple dialog sessions to resolve pronoun and definite reference expressions, and update entity associations in the profile data based on the resolution results.

10. The system according to claim 1, wherein the circuitry is configured to identify whether the request is an information-acquisition request or a schedule-management request based on the analysis result, and route the request to a corresponding external service via the communication interface.

11. The system according to claim 10, wherein the circuitry is configured to acquire schedule information from the schedule management service in response to a schedule-management request, generate updated schedule data based on the intent analysis, and transmit the updated schedule data to the terminal device.

12. The system according to claim 1, wherein the circuitry is configured to apply a sentiment trend analysis model to accumulated profile data stored in the storage device to identify long-term changes in the user's emotional state, and generate updated prompt sentence parameters based on identified trends.

13. The system according to claim 12, wherein the circuitry is configured to generate a status summary report based on the emotional state trend analysis and transmit the status summary report to a designated terminal device via the communication interface.

14. The system according to claim 1, wherein the circuitry is configured to apply a proposal generation model to the profile data and the current emotional state representation to generate a plurality of proposal variants, and rank the variants by alignment with the user's current intention category and emotional state.

15. The system according to claim 14, wherein the circuitry is configured to present the highest-ranked proposal variant to the user via the terminal device, receive a user acceptance or modification response, and update the profile data based on the response.

16. The system according to claim 1, wherein the circuitry is configured to apply a context tracking model to maintain a session context across multiple dialog turns, incorporate the session context in the prompt sentence for each subsequent turn, and update the profile data with new attribute information at the end of each session.

17. The system according to claim 16, wherein the circuitry is configured to apply a session summarization model to accumulated text data from a completed dialog session to generate a structured session summary, and store the session summary in the profile data for use in subsequent prompt sentence generation.

18. A system comprising:
circuitry configured to:
receive, via a communication interface coupled to a packet-switched network, dialog data from a terminal device, apply a speech recognition model to audio signal data and a prosody analysis model to extract prosodic features, and generate text data and a prosodic feature set;
analyze the text data using natural language processing to classify a request type and extract intention attributes, apply an emotion classification model to the text data and the prosodic feature set to generate an emotional state representation with confidence scores, and store the request type, intention attributes, and emotional state representation as profile data in a storage device;
analyze the profile data to identify intention categories, preference patterns, regret patterns, and current concerns, construct a prompt sentence incorporating the identified profile attributes, and input the prompt sentence to a generative AI model to obtain a personalized message or proposal;
transmit the personalized message or proposal to a terminal device associated with a target user via the communication interface, and adjust a response content to the user based on the emotional state representation; and
acquire schedule information or environment information from at least one of a schedule management service and an information-providing service via the communication interface based on the request type.

19. The system according to claim 18, wherein the circuitry is configured to apply a temporal analysis model to accumulated profile data to identify recurring patterns in emotional states and intention categories, incorporate the identified patterns as conditioning parameters in updated prompt sentences, and update the profile data with new attribute information at the end of each dialog session.

20. A method comprising:
receiving, via a communication interface coupled to a packet-switched network, dialog data from a terminal device as an audio signal or a character string, and generating text data by performing a speech recognition process on the audio signal or a character-string acquisition process on the character string;
analyzing the text data by performing natural language processing to interpret a request and an intention of the user, classifying and recognizing an emotional state of the user from the text data, and associating the request, the intention, and the emotional state as attribute information of the user for storage as profile data in a storage device;
determining, based on an analysis result, a type of access to an external information source, acquiring environment information or schedule information from at least one of an information-providing service and a schedule management service via the communication interface, and integrating and managing the acquired information in the storage device;
creating, based on the profile data, a prompt sentence for instructing a generative AI model to generate a message or a proposal for a target user, and inputting the prompt sentence to the generative AI model to obtain generated content; and
transmitting the generated content to a terminal device associated with the target user via the communication interface, and adjusting a response presented to the user on the basis of the recognized emotional state.
